(19) United States
(12) Patent Application Publication
(10) Pub. No.: US 2007/0210047 A1
(43) Pub. Date: Sep. 13, 2007

(54) System and method for automatically clamping a tube in an orbital welder

(76) Inventor: Kent Riley Child, Los Banos, CA (US)

Correspondence Address: HENNEMAN & ASSOCIATES, PLC, 714 W. MICHIGAN AVENUE, THREE RIVERS, MI, 49093, US

(21) Appl. No.: 11/518,852

(22) Filed: Sep. 11, 2006

Related U.S. Application Data
(63) Continuation-in-part of application No. 10/842,208, filed on May 10, 2004, now Pat. No. 7,105,765.

(51) Int. Cl. B23P 17/00; G06F 19/00

(52) U.S. Cl. 219/124.34; 29/890.141; 700/114

(57) ABSTRACT

A novel orbital welder includes a body defining a tube passage, a weld tip, a light source disposed to emit light toward the tube passage such that the emitted light will impinge upon one or more tubes placed in the tube passage, a detector to detect the light emitted by the light source from the tube passage, a clamp adjacent the tube passage, and a control unit operative to close the clamp responsive to a signal from the detector. A method is also disclosed for automatically clamping tubes in an orbital welder when they are properly aligned. The method includes the steps of emitting light from the light source into the tube passage, monitoring the light from the tube passage with the detector, receiving a signal indicative of the position of the tube(s) based on the intensity of the detected light, and automatically closing a clamp depending on the signal from the detector.

### RELATED APPLICATIONS

This application is a continuation-in-part of co-pending U.S. patent application Ser. No. 10/842,208 entitled “System and Method for Aligning Tubes in an Orbital Welder,” filed May 10, 2004 by the same inventor, which is incorporated herein by reference in its entirety.

### BACKGROUND OF THE INVENTION

1. Field of the Invention

This invention relates generally to orbital welders, and more particularly to a novel alignment system facilitating easy tube alignment within orbital welders. This invention also relates to a novel clamping system that facilitates automatic clamping of one or more tubes in an orbital welder.

2. Description of the Background Art

Orbital welders are widely used in the construction of fluid handling systems, for example semiconductor processing equipment. Known orbital welders join metal tubes in an end-to-end fashion by forming a flat, circular weld around the circumference of the tubes' opposing ends. One problem encountered by conventional orbital welders is that the ends of the tubes which are to be joined must be precisely aligned prior to performing the welding operation.

When aligning tubes in an orbital welder, there are several conditions which must be met before the welding operation can begin. First, the seam where the weld will be formed must be aligned with the weld tip to ensure proper bead coverage at the tube interface. Another condition which must be monitored is the alignment of the open ends of the tubes with one another when abutted in the orbital welder. This condition ensures that the mating ends of the tubes are both laterally (axially) aligned and planar (flat) perpendicular to the running directions of the tubes. The final condition required when aligning tubes in an orbital welder is checking the ovality of the mating ends of the tubes to ensure that the mating ends of the tubes are substantially circular.

As a result of these requirements, aligning the mating ends of two tubes within prior art orbital welders has been notoriously time-consuming and/or resulted in a relatively high number of unacceptable welds. For example, it is common for a skilled operator to require a minimum of 5 minutes to align a pair of tubes using such orbital welders. The alignment of tubes is time-consuming because the operator must align the mating ends of the tubes merely by eye, while keeping the above alignment conditions in check. Additionally, the area within the orbital welder where alignment must occur is generally enclosed and not well-illuminated, also hindering the alignment process. Finally, the operator must also prevent external influences, such as the tube clamping process and external vibrations, from upsetting the alignment of the tubes. Clamping tube pieces, and ensuring that the tubes are properly aligned after clamping, also require substantial time and attention from the operator.

FIG. 1 is a top plan view of a typical orbital welder 100, which includes an insulating body 102, tube clamps 104 and 106, a rotor 108, a weld tip 110, and a rotation and voltage controller 112. Clamps 104 and 106 hold tubes 114 and 116, respectively, in position for welding, and are maintained at a common voltage (e.g., ground) and in electrical contact with tubes 114 and 116. Rotor 108 is disposed within body 102 so as to be rotatable about an axis 118 passing through the center of the open ends of tubes 114 and 116. Body 102 provides electrical insulation between rotor 108 and clamps 104 and 106. Rotation and voltage controller 112 functions to rotate rotor 108 within body 102, and to apply a voltage, via rotor 108, to attached weld tip 110.

FIG. 2 shows a cross-sectional view of orbital welder 100, taken along line A-A of FIG. 1. As controller 112 rotates rotor 108 about axis 118 and applies a high voltage to weld tip 110, an arc weld 202 is formed between the open ends of tubes 114 and 116. Because clamps 104 and 106 are held at the common voltage, they must be displaced a safe distance from weld tip 110, so as not to generate an arc there between. The distance between clamps 104 and 106 and the open ends of tubes 114 and 116 makes alignment of the open ends of tubes 114 and 116 more difficult. In addition, when engaging clamps 104 and 106, an operator of orbital welder 100 could inadvertently jar one or more of tubes 114 and/or 116 out of proper alignment. Moreover, as discussed above, the interior chambers of known orbital welders are dark, and, therefore, visual confirmation of proper alignment is difficult.

What is needed is an orbital welder that facilitates efficient alignment of the tube pieces that are to be welded. What is also needed is an orbital welder that facilitates easy confirmation of proper alignment. What is also needed is an orbital welder that facilitates efficient clamping of tubes and prevents misalignment of one or more of the tubes during the clamping process.

### SUMMARY

The present invention overcomes the problems associated with the prior art by providing an orbital welder including a novel alignment system. The invention facilitates efficient alignment of the mating ends of a pair of tubes within the orbital welder.

A novel orbital welder includes a body defining a tube passage, a weld tip, a rotor, a light source disposed to emit light toward the tube passage to impinge on one or more tubes placed in the tube passage, and a detector disposed to detect the light emitted by the light source from the tube passage. The detected light may be transmitted directly from the light source or reflected form one or both of the tubes. In either case, the intensity of the light detected by the detector depends on the position of the tube(s) in the tube passage. In a particular embodiment, the light source includes at least one laser. Optionally, the light source and the detector are embodied in a single unit. The orbital welder also includes at least one clamp to retain the tube in the tube passage. Optionally, the clamp can be operative to automatically engage the tube responsive to a predetermined intensity of detected light.

The intensity of detected light is indicative of several aspects of alignment. In one case, the detected light is indicative of the position of an end of the tube with respect to the weld tip. For example, when the tube placed in the tube passage is aligned with the weld tip, the emitted light will partially impinge upon the mating end of the tube. As another example, the tube defines a Z-axis, and the intensity of the detected light is indicative of the alignment of a second tube with respect to the Z-axis defined by the first tube. As yet another example, the intensity of the detected light is indicative of the ovality of the tube or a second tube abutted with the first tube in the tube passage.

The positions of the light source and the light detector are also adjustable. In one embodiment, the light source is disposed to emit light along a first direction, and the detector is disposed to detect light traveling along a second direction, wherein the first direction and the second direction are adjustable. In another embodiment, the light source is adjustable with respect to the tube passage to focus the emitted light to a particular spot size, for example less than 600 microns, on tubes of various diameters.

In one embodiment, the rotor defines at least one aperture such that the light source can emit light into the tube passage through the rotor. The detector is also disposed to detect light reflected from the tube passage through the aperture in the rotor. Alternatively, the rotor includes a second aperture formed there through, and the detector is positioned to detect light emitted through the second aperture.

In a particular embodiment, the detector detects light reflected off the tube in the tube passage, and in an alternate particular embodiment, the detector is disposed to detect transmitted light that is not blocked by the tube placed in the tube passage. In either case, the orbital welder can include a plurality of light sources, a plurality of detectors, or a plurality of each.

In another particular embodiment, the orbital welder includes an indicator operative to indicate the intensity of the detected light. The indicator is operative to display the intensity of detected light, and in a more particular embodiment, to display a target intensity indicative of a target alignment position of the tube in the tube passage. Optionally, the indicator can be one or more lights (e.g., red and green LEDs), which are driven according to the intensity of the detected light to simply light up when particular alignment conditions are met or not met.

In the reflective system, the indicator is operative to indicate when the intensity of detected light is below a first predetermined level (e.g., less than 5% of an emitted intensity). In addition, the indicator is further operative to indicate when the intensity of detected light is above a second predetermined intensity (e.g., at least 95% of an emitted intensity). The indicator is also operative to indicate when the intensity of the detected has reached a third predetermined intensity (e.g., 50%±2.5% of an emitted intensity) indicative of alignment of a mating end of the tube with the weld tip. The indicator is further operative to indicate when the intensity of detected light has reached a fourth predetermined intensity (e.g., 80%±2.5% of an emitted intensity) indicative of alignment of a mating end of a second tube with the mating end of the first tube, and if one or both of the first and second tubes is/are rotated, the indicator is operative to indicate if the intensity of detected light deviates by more than 20% of the fourth predetermined intensity.

In the transmissive system, the indicator is operative to indicate when the intensity of light is above a first predetermined intensity (e.g., at least 95% of an emitted intensity) indicative of no light impinging upon the tube. Additionally, the indicator is operative to indicate when the intensity of detected light is below a second predetermined intensity (e.g., at most 5% of an emitted intensity) indicative of all the emitted light impinging on the tube. The indicator is also operative to indicate when the intensity of detected light has reached a third predetermined intensity (e.g., 50%±2.5% of an emitted intensity) indicative of alignment of a mating end of the tube with the weld tip. The indicator is further operative to indicate when the intensity of detected light has reached a fourth predetermined intensity (e.g., 20%±2.5%) indicative of alignment of a mating end of a second tube with the mating end of the first tube, and if one or both of the first and second tubes is/are rotated, the indicator is operative to indicate if the intensity of detected light deviates by more than 20% of the fourth predetermined intensity.

A method for aligning one or more tubes in an orbital welder having a tube passage, a light source, and a light detector is also disclosed, and includes the steps of emitting light from the light source into the tube passage, monitoring the light from the tube passage with the detector, and providing a signal indicative of the position of a tube (or a tube fitting) disposed in the tube passage based on the intensity of light monitored by the detector. In one particular method, the step of emitting light from a light source includes emitting light from a laser. In another particular method, the step of monitoring light from the tube passage includes monitoring light reflected off a tube disposed in the tube passage, and in alternate particular embodiment, the step of monitoring light from the tube passage includes monitoring light not blocked by a tube disposed in the tube passage.

In another particular method, the orbital welder includes a rotor defining an aperture there through, and the step of emitting light into the tube passage includes emitting light through the aperture in the rotor. Optionally, the rotor defines a second aperture there through, and the step of monitoring light from the tube passage includes monitoring light not blocked by the tube emanating through the second aperture.

In still another particular method, the orbital welder includes a weld tip, and the step of providing a signal includes providing a signal when the monitored intensity is indicative of a pre-tacked pair of tubes being in alignment with the weld tip.

In another particular method, the orbital welder includes a weld tip, and the step of providing a signal includes providing a signal when the monitored intensity is indicative of a mating end of the tube being in alignment with the weld tip. Additionally, the method includes the step of providing a second signal indicative of a second tube abutting the tube disposed in the tube passage based on the intensity of light monitored by the detector. In still a more particular method, the step of monitoring light from the tube passage includes monitoring light while the second tube is rotated, and providing a third signal if the intensity of the monitored light changes beyond a predetermined range (e.g., ±20% of the second predetermined intensity) while the second tube is rotated.

A novel orbital welder and clamping system includes a body defining a tube passage, a weld tip, a light source disposed to emit light toward the tube passage such that the emitted light will at least partially impinge upon a tube placed therein, a detector disposed to detect light emitted by the light source from the tube passage, at least one clamp disposed adjacent to the tube passage, and a control unit operative to automatically close the clamp responsive to a signal from the detector.

In a particular embodiment, the signal from the detector is an intensity signal, and the control unit is operative to close the clamp responsive to the detector detecting a first predetermined intensity (e.g., 50% (±2.5%) of a maximum detectable intensity) indicating that a mating end of the tube is aligned with the weld tip. The welder can also include a second clamp disposed adjacent the tube passage opposite the first clamp. In such a case, the control unit is further operative to close the second clamp responsive to the detector detecting a second predetermined intensity signal indicative of the alignment of a mating end of a second tube with the mating end of the first tube.

In a particular embodiment, the second predetermined intensity is 80% (±2.5%) of the maximum reflectance if the detector is disposed to detect light reflected off the tube and second tube. Alternately, if the detector is disposed to detect light transmitted past the tube and second tube, then the second predetermined intensity is 20% (±2.5%) of a maximum transmittance value. Extra alignment operations can also be performed, during which the control unit determines if the intensity of detected light deviates beyond a predetermined range of the second predetermined intensity (e.g., ±15% of the maximum detectable intensity) before closing the second clamp. If so, the control unit prevents the clamp from closing.

The clamping system can also include an operator controller to perform various operations. For example, the operator controller can indicate to the control unit that an alignment operation performed on the second tube is complete. As another example, the operator controller is operative to instruct the control unit to release one or both of the tubes from the clamps.

In addition to the operator controller, the clamping system can also include an indicator to display alignment data indicative of the alignment of one or both of the tubes placed in the clamps. In a particular embodiment, the indicator receives alignment data from the control unit.

A method for automatically clamping a tube in an orbital welder having a tube passage, a light source, a light detector, and a clamp is also disclosed and includes emitting light from the light source into the tube passage, monitoring light from the tube passage with the detector, receiving a signal from the detector indicative of the position of a tube in the tube passage, and closing the clamp responsive to the signal from the detector.

In a particular method, the signal from the detector is an intensity signal and the step of closing the clamp includes closing the clamp when a first predetermined intensity is received from the detector indicative of a mating end of the tube aligning with the weld tip. The welder can also include a second clamp such that the method further includes a step of closing the second clamp when a second predetermined intensity is received from the detector indicative of a mating end of the second tube aligning with the mating end of the first tube. Before closing the second clamp, the method can optionally include the steps of monitoring light from the tube passage while the second tube is rotated, receiving a signal from the detector indicative of the intensity of the monitored light deviating from the second predetermined intensity, and preventing the second clamp from closing if the intensity of the monitored light deviates outside a predetermined range (e.g., ±20% of the second predetermined intensity). Optionally, before closing the second clamp, the method includes receiving a signal from an operator of the orbital welder via an operator controller indicating that the second tube has been completely rotated.

A more particular method includes the step of welding the first and second tube together. Optionally, the tubes can be welded together after receiving a signal from an operator of the orbital welder via an operator controller.

Another particular method includes receiving an open signal from the operator of the orbital welder via the operator controller such that one or both of the clamps are opened.

Still another particular method includes providing alignment data (e.g., intensity data) to an indicator, wherein the alignment data is indicative of the alignment of a mating end of the tube with respect to a weld tip. The alignment data can also indicate the alignment of a mating end of a second tube with respect to the mating end of the first tube.

A novel clamp includes a frame having a first arm and a second arm, a first jaw rotatably coupled to the first arm and selectively engaging the second arm, a second jaw slidably mounted to the first arm and the second arm, and a force actuator disposed to engage the second jaw and move the second jaw toward the first jaw when the force actuator is activated. The first jaw defines a first portion of a clamping passage for receiving a tube, and the second jaw defines a second portion of the clamping passage, complementary to the first portion of the clamping passage. The clamping passages are semi-circular such that the clamp can accommodate tubes having a variety of diameters.

The clamp also includes a first latch pivotally coupled to the first jaw and a second latch pivotally coupled to the second arm. The second latch is disposed to selectively engage the first latch when the first jaw is rotated toward the second jaw. The clamp can also include a release device disposed to selectively bias one of the first and second latches away from the other.

The force actuator is designed to close the clamp by moving the second jaw toward the first jaw. In one embodiment, the force actuator is a solenoid (e.g., pneumatic or electromagnetic) having an extendable ram to push the second jaw toward the first jaw. In an alternate embodiment, the force actuator includes a jack screw coupled to the second jaw and an electric motor coupled to the jack screw, such that turning the motor moves the second jaw with respect to the first jaw.

### BRIEF DESCRIPTION OF THE DRAWINGS

The present invention is described with reference to the following drawings, wherein like reference numbers denote substantially similar elements:

FIG. 1 is a top view of a prior art orbital welder;

FIG. 2 is a cross-sectional view of the orbital welder of FIG. 1, taken along line A-A;

FIG. 3 is a top view of an orbital welder incorporating one embodiment of a reflective tube alignment system of the present invention;

FIG. 4 is a side perspective view looking into the body of the orbital welder of FIG. 3;

FIG. 5 is a side view of the rotor of FIG. 3;

FIG. 6A is a bottom view showing light impinging on a mating end of the tube inserted in the orbital welder of FIG. 1;

FIG. 6B is a front view showing light impinging on a mating end of the tube inserted in the orbital welder of FIG. 1;

FIG. 6C is a front view showing light impinging on the mating ends of two tubes inserted in the orbital welder of FIG. 1;

FIG. 7 is a top view of an orbital welder including another embodiment of a reflective tube alignment system of the present invention;

FIG. 8 is a top view of an orbital welder including one embodiment of a transmissive tube alignment system of the present invention;

FIG. 9 shows a pipe in a plurality of positions being impinged upon by a light source of the alignment system of the present invention;

FIG. 10 is a table displaying example detected light intensities for the tube positions of FIG. 9 for both transmissive and reflective alignment systems of the present invention;

FIG. 11 shows one embodiment of an indicator for use with the alignment systems of the present invention;

FIG. 12 is a table displaying possible indicator modes of the indicator of FIG. 10 depending on the position of a tube in an orbital welder of the present invention;

FIG. 13 is a flowchart summarizing one method of aligning at least one tube in an orbital welder of the present invention;

FIG. 14 is a flowchart summarizing one method of using an orbital welder of the present invention to weld two pre-tacked tubes together;

FIG. 15 is a flowchart summarizing one method of using an orbital welder of the present invention to weld two tubes or a tube fitting and a tube together;

FIG. 16 is a block diagram of an orbital welder incorporating an auto-clamping system according to the present invention;

FIG. 17 is a front view of an auto-clamp of the present invention in an open position;

FIG. 18 is a front view of an auto-clamp of the present invention in a soft-clamp position;

FIG. 19 is a front view of an auto-clamp of the present invention in a closed position;

FIG. 20 is a right side view of the auto-clamp of FIG. 18;

FIG. 21 is a left side view of the auto-clamp of FIG. 18;

FIG. 22 is a block diagram of the system controller of FIG. 16 according to the present invention;

FIG. 23 is one example of the combination indicator and operator controller of FIG. 16 according to the present invention;

FIG. 24 is a flowchart summarizing one method of automatically clamping a tube in an orbital welder according to the present invention; and

FIG. 25 is a flowchart summarizing one method of using the orbital welder and the clamping system of the present invention to clamp and weld two tubes together.

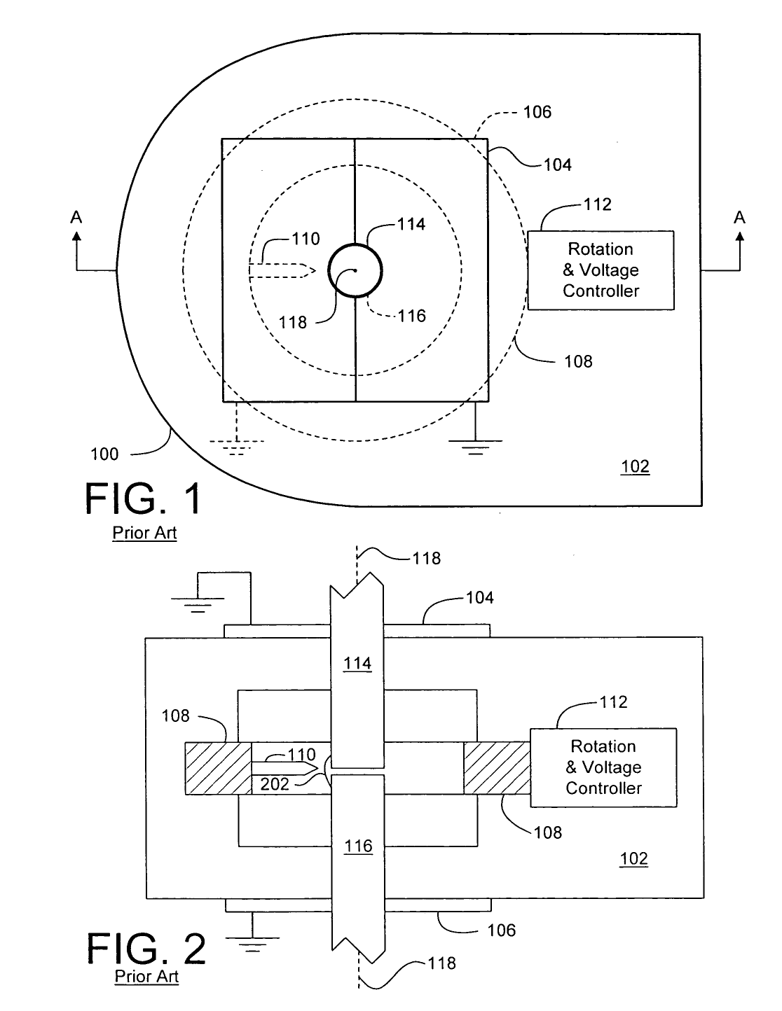

### DETAILED DESCRIPTION

The present invention overcomes the problems associated with the prior art by providing an orbital welder including a novel alignment system capable of aligning the mating ends of a plurality of tubes within a tube passage of the orbital welder. In the following description, numerous specific details are set forth (e.g., specific detected intensity percentages, indicator and operator controller configurations, etc.) in order to provide a thorough understanding of the invention. Those skilled in the art will recognize, however, that the invention may be practiced apart from these specific details. In other instances, well known details of clamp system design (e.g., power sources for the clamp actuators, specific clamp mounting materials, etc.) have been omitted, so as not to unnecessarily obscure the present invention.

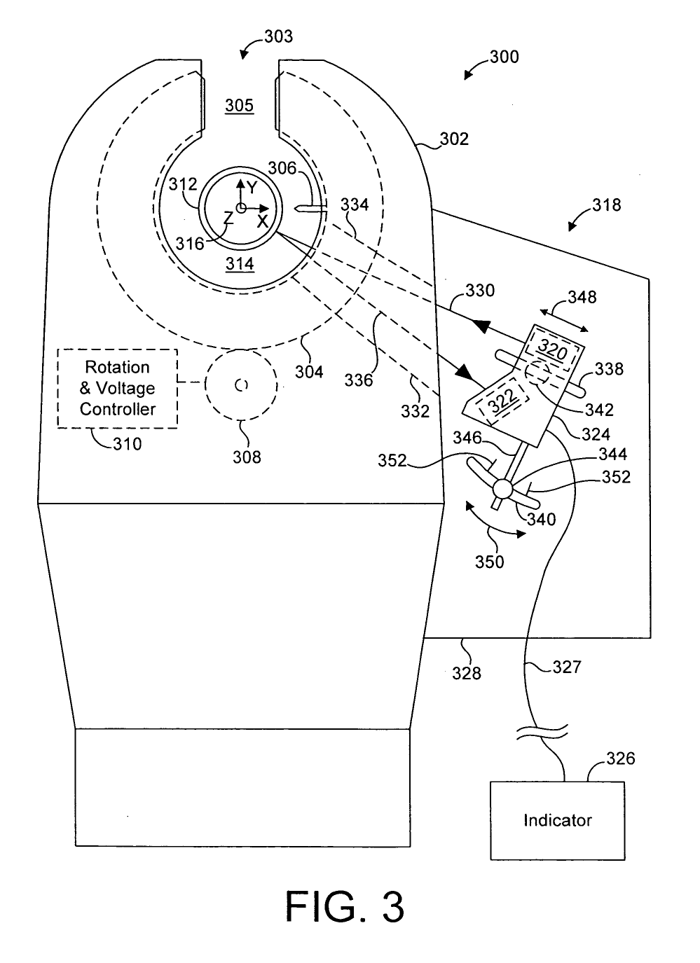

FIG. 3 shows an orbital welder 300 including an alignment system of the present invention. Orbital welder 300 includes an insulating body 302 defining a window 303, a rotor 304 defining an open section 305, a weld tip 306, a drive mechanism 308, and a rotation and voltage controller 310. Orbital welder 300 also includes a plurality of clamps (not shown in the present view for purposes of clarity), which retain portions of the one or more tubes in position within body 302 and maintain the tube(s) at a common voltage (e.g., ground). As shown in FIG. 3, a single tube 312 is retained in a tube passage 314 of body 302.

The components of orbital welder 300 perform the following functions. Body 302 provides electrical insulation between the clamps and weld tip 306, and generally provides a support structure for the other components of orbital welder 300. Rotor 304 is disposed within body 302 so as to be rotatable about a Z axis 316 passing through the center of tube 312 and tube passage 314. When rotor 304 is in a home position, removed section 305 is aligned with window 303 such that an operator of welder 300 can look into tube passage 314. Weld tip 306 is mounted to rotor 304, and when high voltage is applied and rotor 304 is rotated, weld tip 306 is disposed to generate an arc weld at the seam between tube 312 and a second tube (not shown) placed in tube passage 314. Drive mechanism 308 includes a drive and gear train that is controlled by rotation and voltage controller 310, and is disposed to mesh with a toothed outer surface (not shown in this view) of rotor 304 to cause rotor 304 to rotate about Z axis 316 responsive to a signal from controller 310. Rotation and voltage controller 310 functions to rotate rotor 304 within housing 302 by controlling drive mechanism 308, and to apply a voltage, either via rotor 304 or other electrical connection, to weld tip 306. Tube passage 314 is defined by body 302 and rotor 304, and functions to receive two tubes that are to be welded together by weld tip 306. Optionally, tube passage 314 can be adapted to receive a tube fitting (e.g., a T-fitting) to be welded to a run tube or a branch tube.

Orbital welder 300 also includes an alignment system 318, which facilitates proper alignment of tube 312 (and a second tube to be welded to tube 312) within tube passage 314. Alignment system 318 includes a light source 320 and a light detector 322, which are both enclosed within an alignment package 324. Alignment system 318 also includes an indicator 326, coupled to alignment package 324 via a cable 327, and a mounting bracket 328.

Alignment system 318 operates as follows. Light source 320 emits light along a first direction 330 through a passage 332 formed in body 302 and a slot 334 formed through the side of rotor 304 (passage 332 and slot 334 shown in phantom). The light impinges on tube 312 in tube passage 314, is partially reflected, and travels along a second direction 336 through slot 334 of rotor 304 and passage 332 of body 302. Light detector 322 monitors the intensity of light received from tube passage 314 along second direction 336, and provides a signal to indicator 326 indicative of the monitored intensity. Indicator 326 displays the monitored intensity (and optionally the emitted intensity from light source 320) to an operator of orbital welder 300. When a predetermined intensity of detected light is received by detector 322 and indicated by indicator 326, the operator knows tube 312 is properly aligned in tube passage 314.

Mount 328 structurally supports light source 320, light detector 322, and optionally indicator 326, and is coupled to the side of body 302 adjacent passage 332. In this embodiment, mount 328 is a sheet metal bracket manufactured to conform to the shape of body 302. Mount 328 also includes a first alignment slot 338 and a second alignment slot 340 to aid in the adjustment of alignment package 324. Additionally, alignment package 324 includes a first alignment slider 342 and a second alignment slider 344 attached to alignment package 324 via arm 346. Slider 342 passes through first alignment slot 338 from the bottom and engages the underside of alignment package 324. Slider 342 rotatably engages (e.g., by a nut and bolt) alignment package 324 such that alignment package can be tightened against mount 328. Loosening slider 342 allows alignment package to be adjusted toward and away from body 302 in the direction of arrow 348. Similarly, slider 344 passes through arm 346 and slidably engages second alignment slot 340. When slider 342 is loosened, slider 344 can be moved along the arc defined by second alignment slot 340 in the direction of the arrow 350. Slider 344 facilitates the rotation of alignment package 324 into proper position such that light source 320 and light detector 322 can emit and receive light to and from tube passage 314. In the present embodiment, alignment package 324 is situated such that the light emitted along light path 330 is focused to impinge on the outer-diameter of tube 312 as a spot.

A plurality of indicia 352 allow alignment package 324 to be rotated into a plurality of present positions corresponding to various particular diameters of tube 312. Similar indicia can be placed adjacent alignment slot 338 to facilitate easy focusing of light emitted by light source 320 on tube 312.

In this particular embodiment, slider 342 is a round-headed screw adapted to engage a nut seated in alignment package 324. Similarly, slider 344 is also a round-headed screw, and optionally engages a nut located below mount 328 to facilitate snugging against mount 328.

As an alternative to the manual adjustment means described above, alignment package 324 can optionally be fitted with an automated adjustment means, which via electronic control could automatically adjust the position of alignment package 324. For example, alignment package 324 could be mounted to a servo motor in order to provide automated rotational movement. As another example, alignment package 324 could also be attached to a proportional slider to provide movement with respect to tube passage 314. Such automated adjustment devices would provide automated adjustment of alignment package 324 such that the light emitted along light path 330 could be focused to impinge on the outer-diameter of tubes having different diameters.

In the present embodiment, alignment package 324 is commercially available from the Keyence Corporation of Osaka, Japan as Digital Laser Optic Sensor, model number LV-H37. The LV-H37 focuses six lasers, positioned radially, to travel along first direction 330. The LV-H37 has one detector, which detects the intensity of the combined reflected laser light.

It should be noted that other light sources and light detectors can be employed in the present invention. For example, fiber optics could be positioned directly in the tube passage along with a detector. As another example, light emitted from a laser diode could be focused using lenses to impinge on tube(s) placed in tube passage 314. The detector, in the simplest case could be a simple photo-voltaic cell.

It should also be noted that in the current embodiment, alignment system 318 is shown as a retrofit to orbital welder 300. In this regard, alignment system 318 can be fitted to many different styles of orbital welders as a simple add-on device with minimal modification to the welder. However, it is also anticipated that in mass production alignment package 324 would be permanently mounted within body 302, and indicator 326 would be permanently mounted to body 302, thereby eliminating the need for mount 328.

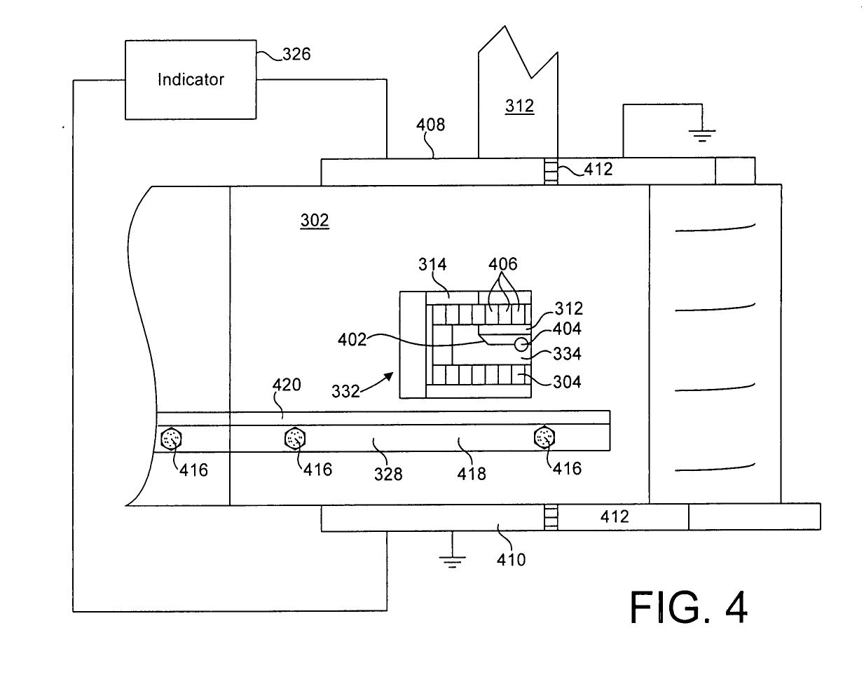

FIG. 4 is a side view looking into orbital welder 300 along first direction 330 of FIG. 3 with alignment package 324 removed from view. In FIG. 4, tube 312 is shown extending from outside the top of body 302 down into tube passage 314. Tube 312 is also shown to include a beveled edge 402. A laser spot 404, emitted along first direction 330 by light source 320, is partially impinging upon beveled edge 402 of tube 312.

Rotor 304 is also shown in FIG. 4 to include a plurality of gear teeth 406 arranged around its circumference. Gear teeth 406 mesh with the teeth on gears of drive mechanism 308, causing rotor 304 to rotate when drive mechanism 308 is actuated by rotation and voltage controller 310.

Orbital welder 300 also includes a pair of clamps 408 and 410. Clamps 408 and 410 hold tube 312 and a second tube (not shown), respectively, in position for welding, and are maintained at a common voltage (e.g., ground) and in electrical contact with their respective tube. Each of clamps 408 and 410 are simple collet-style clamps, and each rotate between open and closed positions around a hinge 412. In the present view, clamp 408 is shown in a closed position and clamp 410 is shown in an open position, waiting positioning of a second tube therein.

In a particular embodiment, clamps 408 and 410 operate automatically, responsive to a signal from indicator 326, to clamp a tube (e.g., tube 312) placed there through, when the tube is properly aligned within tube passage 314. For example, indicator 326 is operative to monitor the light intensity detected by light detector 322. Then, responsive to a predetermined intensity indicative of proper alignment of tube 312 in tube passage 314, indicator 326 signals clamp 408 to automatically engage tube 312. Similarly, when a tube was placed in clamp 410, and proper alignment within tube passage 314 was established, indicator 326, responsive to another predetermined intensity of detected light, would signal clamp 410 to engage the tube placed therein.

Optionally, the automatic clamps 408 and/or 410 include an intermediate clamped state. For example, the clamps initially allow substantially unrestricted movement of tube 312 along the z-axis. Then, when the intensity of detected light begins to approach the desired value, the clamp will partially engage (“soft-clamp”) tube 312 such that tube 312 can still be manipulated, but not as freely as in the unclamped state. The soft-clamp state makes it easier for the operator to make small changes in the position of tube 312.

Mount 328 is also shown in the present view to be coupled directly to body 302 via a plurality of fasteners 416 (e.g., sheet metal screws, bolts, etc.). In the present embodiment, mount 328 is formed from sheet metal and defines a lip 418, which is bent downward from a platform section 420 to facilitate easy connection of mount 328 to body 302. Platform 420 defines a flat surface to which components of alignment system 318 can be easily mounted.

Optionally, mount 328 can include an encasement (not shown), which would attach to body 302 surrounding passage 332. Such an encasement would shield passage 332 and alignment package 324 from surrounding sources of light, which could interfere with the operation of light source 320 and light detector 322.

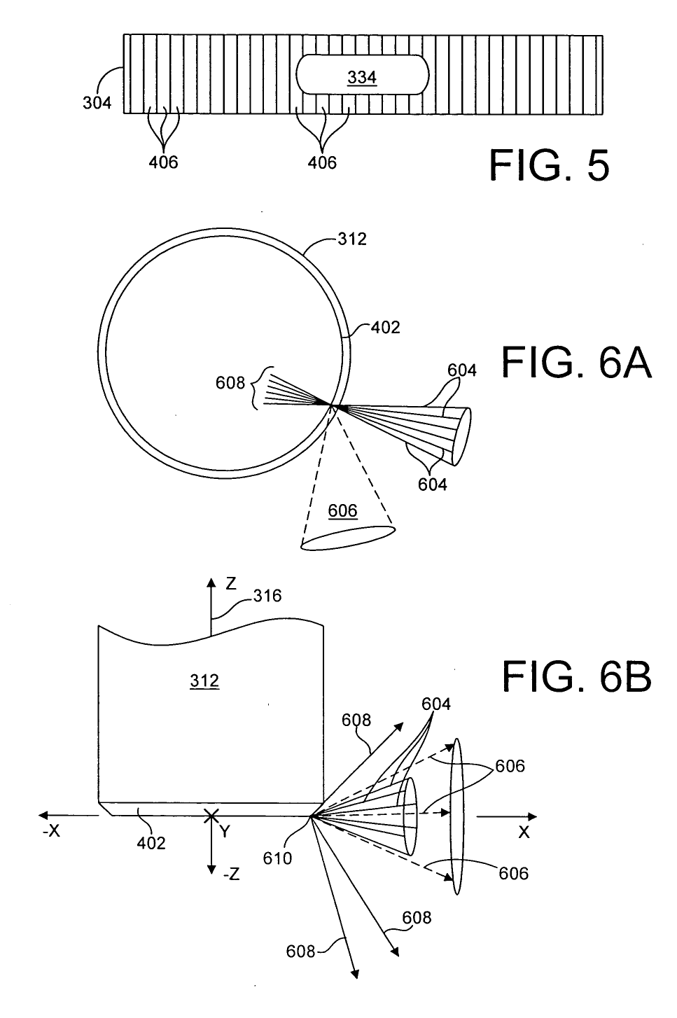

FIG. 5 shows a side view of rotor 304 removed from orbital welder 300. FIG. 5 clearly shows that rotor 304 includes gear teeth 406 around its outer circumferential edge. In addition, slot 334 is shown formed through the side of rotor 304. In the present embodiment, rotor 304 is constructed from metal. Accordingly, slot 334 can be formed through the side of rotor 304 by methods known in the machining arts. Slot 334 is formed wide enough so that the light emitted from light source 320 can pass unobstructed through rotor 304, and so that light can be reflected from tube passage 314 back through slot 334 to light detector 322. It should also be noted that slot 334 need only be wide enough to not obstruct light emitter 320 and light detector 322 when rotor 304 is located in a home position (e.g., such that slot 334 is aligned with passage 332 in body 102).

Keeping the angle between the first direction 330 and the second direction 336 relatively small minimizes the required size of slot 334. In this particular embodiment, the angle between first direction 330 and second direction 336 is approximately 13 degrees.

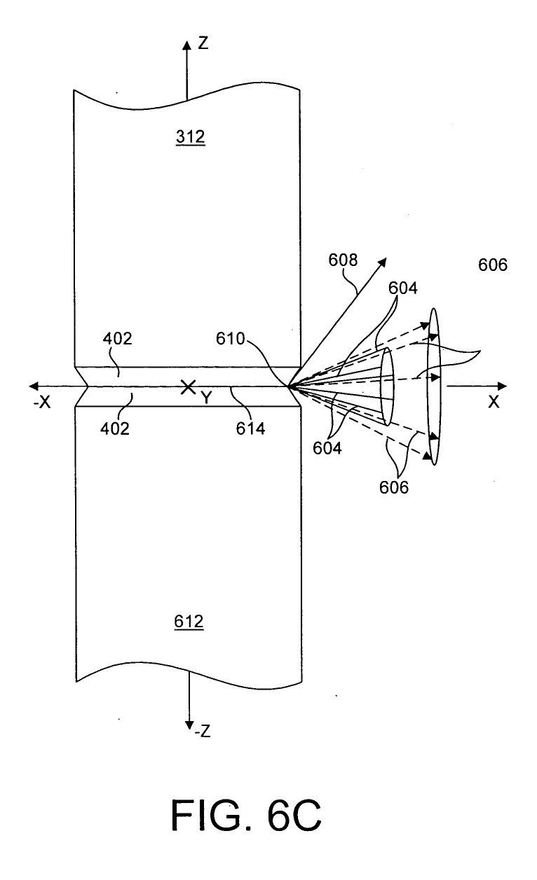

FIG. 6A is a bottom view looking along the z-axis (see FIG. 6B) into the mating end of tube 312 in tube passage 314. A plurality of light rays 604 (indicated by solid lines) emitted by light source 320 are partially impinging upon the beveled mating edge 402 of tube 312. A portion of the light rays 604 are reflected off of tube 312 as a reflected beam 606 (indicated by broken lines). The remaining portion 608 of light rays 604, which are not reflected by tube 312, are scattered in the interior of tube 312 or in tube passage 314, and are not detected by light detector 322. The intensity of reflected beam 606 is indicative of the position of the end of tube 602 in tube passage 314.

FIG. 6B is a front view of the mating end of tube 312 in tube passage 314. The present view shows that the incident light rays 604 impinge on a shoulder 610 of beveled edge 402 near the inner diameter of tube 312, as shown similarly in FIG. 4. Of the incident light rays 604, approximately half are reflected back to light detector 322, as reflected light rays 606. The remaining rays 604 are scattered as scattered light rays 608, and do not impinge on detector 322.

Alignment with weld tip 306 is achieved because alignment system 318 is disposed to detect when tube 312 breaks the X-Y plane (a plane perpendicular to the plane of the page and passing through the X-axis). Weld tip 306 is also disposed in the X-Y plane, and travels radially around the bevels of mating end 402 of tube 312 to form an arc weld when a second tube is aligned with tube 312. Accordingly, the moment the mating end of tube 312 breaks the X-Y plane, shoulder 610 of bevel 402 is aligned with weld tip 306 at least along Z-axis 316.

The inventor has determined empirically that when a first tube (e.g., tube 312) is properly aligned with weld tip 306, approximately 50% (±2.5%) of the total light intensity emitted by light source 320 is reflected back to light detector 322 from tube passage 314. If tube 312 has not been inserted enough to be impinged upon by light emitted by light emitter 320, the inventor has found that less than 5% of the emitted intensity will be detected. Similarly, if tube 312 is inserted too far into tube passage such that all the light emitted by light source 320 impinges upon tube 312, the inventor has found that the intensity detected by light detector 322 will be at least 95% of the maximum detectable intensity.

In the embodiment shown, the location of the end of tube 312 with respect to the X-Y plane can be precisely determined, because incident rays 604 are focused to a spot of light that is small relative to the dimensions of tube 312. For example, in the embodiment shown, the emitted light is focused to a spot having a diameter of approximately 50 microns (μm), or .002 inches. This size is even smaller than the bevel formed on the end of tube 312. If smaller or larger tubes are to be welded, the laser spot size can be adjusted accordingly, depending on the precision required for a particular application.

FIG. 6C is a front view of a second tube 612 abutting tube 312 in tube passage 314. Like tube 312, second tube 612 also has a beveled edge 402. In the present view, tube 612 is properly aligned with first tube 312. Emitted light rays 604 impinge at a seam 614 between the mating ends of tube 312 and second tube 314. Because there is very little gap between tube 312 and tube 612 at seam 614 when tubes 312 and 612 are properly aligned, most of the emitted light rays 604 are reflected as reflected beams 606, which are received by light detector 322. Only a small portion of the emitted light 604 is scattered, and is indicated by scattered light ray 608.

The present embodiment shows proper alignment of tube 312 and tube 612 in tube passage 314. First, the mating ends of both tube 312 and tube 612 are properly aligned with weld tip 306 because the shoulder 610 of tube 312 and the shoulder of second tube 612 lie approximately within the X-Y plane. Second, both first tube 312 and second tube 612 are laterally aligned with each other along the X-axis and Y-axis. In other words, tube 312 and tube 612 are axially aligned. Third, neither of tube 312 or second tube 612 is out of round.

Each of the above alignment conditions can be verified by the intensity of reflected light detected by light detector 322. As indicated above, first tube 314 is properly inserted and aligned with weld tip 306 when the intensity detected by light detector 322 is approximately 50% (±2.5%) of the maximum reflectance. Note that the maximum reflectance is determined by positioning a clean, round tube completely through the X-Y plane and measuring the reflected light intensity. Then, after first tube 312 is correctly inserted and aligned with weld tip 306, second tube 612 can be inserted into tube passage 314. When second tube 612 is properly aligned with weld tip 306, and the mating ends of tubes 312 and 612 are properly aligned with one another about the Z-axis, the inventor has discovered that the intensity of light detected by light detector 322 is approximately 80% (±2.5%) of the maximum reflectance. Similarly, if tubes 312 and 612 are pre-tacked together before being inserted into tube passage 314, proper alignment of the pre-tacked seam with weld tip 306 is also indicated by light detector 322 detecting approximately 80% (±2.5%) of the maximum reflectance.

As stated previously, because emitted light rays 604 are focused to such a small point, very minute misalignments are indicated by the detected intensity of reflected light. For example, if one of tubes 312 and 612 is misaligned either along the X-axis or Y-axis, the intensity of light detected by light detector 322 will be out of the range of 80% (±2.5%) because a slight ridge will be formed where light rays 604 impinge on seam 614. Similarly, if one of tubes 312 or 612 is skewed into the X-Y, X-Z and/or Y-Z planes, the detected intensity will also be out of the range 80% (±2.5%), because a small gap will be formed at the point where light rays 604 impinge on seam 614.

The ovality of tubes 312 and 612 can also be determined by monitoring the intensity of reflected light 606 when tube 312 and/or tube 612 are rotated. For example, after a welder inserts second tube 612 into tube passage 314 and determines that the intensity of detected light was approximately 80% (±2.5%) of the maximum reflectance, the welder then rotates second tube 612 and monitors the intensity of detected light (e.g., via indicator 326) for a substantial deviation in the detected intensity. The inventor has determined that if, during rotation of the second tube, the intensity of light detected by light detector 322 deviates by more than (±20%) of the original value (e.g., 80%), then the mating end of either tube 312 or tube 612 could be out-of-round. If, upon further investigation, it is determined that neither tube 312 nor second tube 612 is out-of-round, then such a deviation in detected light intensity would indicate that one or both of tubes 312 and 612 is misaligned in one or more of the X-Y, X-Z or Y-Z planes.

As stated previously, when tube 312 is inserted into tube passage 314 beyond weld tip 306, the light detected by light detector 322 will be at least 95% of the maximum reflectance, because all of the emitted light 604 would be impinging on the outer surface of tube 312. Contrast this with the 80% of maximum reflectance detected when second tube 612 is inserted into tube passage 314 to abut tube 312. The difference in values between these two cases is due to seam 614, which is created when the mating ends of tubes 312 and 612 are abutted. Seam 614 reduces the detectable intensity of reflected light, because seam 614 will scatter more of the emitted light 604 than will the smooth outer surface of tube 312.

It should be noted that the specific values outlined above are only representational values. Indeed, depending on the components used to construct the orbital welder and the alignment system of the present invention, as well as the physical properties of the tubes being welded, the reflectance percentages outlined above indicating particular states of alignment may vary. It is anticipated by the inventor that each orbital welder incorporating the present alignment system will have to undergo a calibration process to determine maximum reflectance and the percentages of maximum reflectance corresponding to the various alignment conditions.

The calibration process is accomplished as follows. First, the alignment system is powered, and the detected intensity measured with no tube in tube passage 314. This measurement provides an intensity indicative of no light impinging on a tube placed in tube passage 314. Second, a tube is placed in tube passage such that all the light emitted from light source 320 impinges on the side wall of the tube, thereby yielding an intensity indicative of a tube being inserted too far into tube passage 314. Third, a tube must be aligned with weld tip 306 such that it just lies in the X-Y plane, and is coaxial with the Z-axis 316. Then a third intensity reading indicative of a single tube (e.g., tube 312) aligned with weld tip 306 can be measured. Finally, the last calibration step includes inserting a pair of pre-aligned tubes into tube passage 314, and manually aligning the seam with weld tip 306, and verifying that the tubes are properly situated along Z-axis 316. Then an intensity reading indicative of a pair of tubes properly aligned with weld tip 306 can be taken. Advantageously, “standard” tubes that are known to have the desired physical characteristics are used in the calibration process.

It should be noted that the calibration process can be carried out in either light-field or dark-field modes. In light field mode, the calibration process occurs under ambient lighting conditions, such that any interference from the ambient light would be eliminated by the calibration process (i.e., the only concern is the change in intensity with respect to predefined points, and not the intensity values themselves). In dark field mode, the calibration process occurs with no or minimal ambient lighting conditions. Dark field mode calibration is well suited for an alignment system that is generally enclosed within the orbital welder.

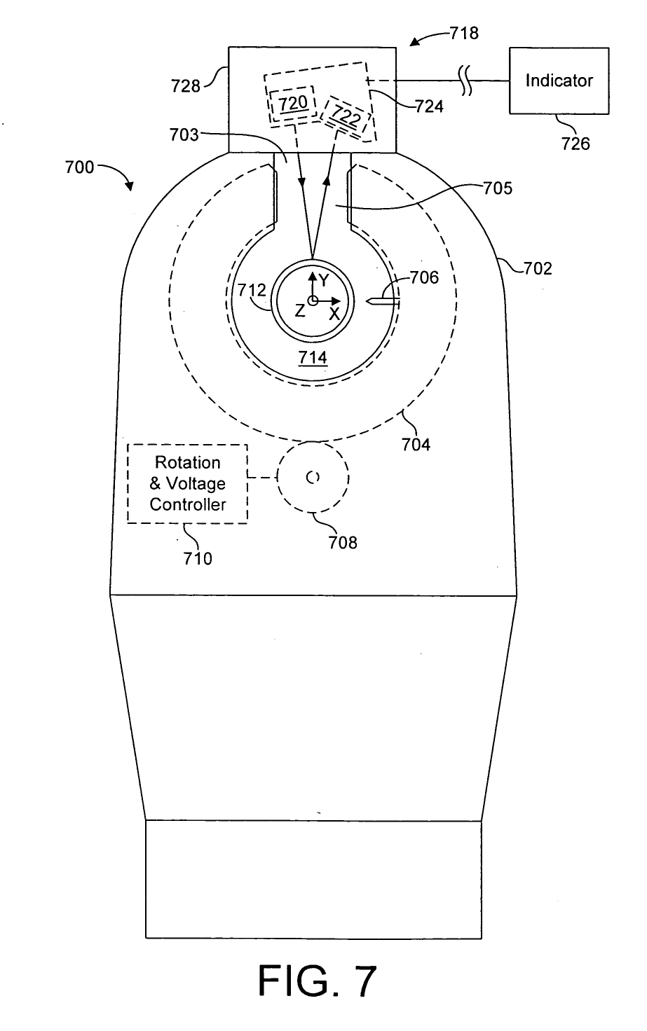

FIG. 7 shows a top view of an orbital welder 700 including an alternate embodiment of an alignment system of the present invention. Similar to orbital welder 300, orbital welder 700 includes an insulating body 702 defining a window 703, a rotor 704 defining an open section 705, a weld tip 706, a drive mechanism 708, and a rotation and voltage controller 710. Orbital welder 700 also includes a plurality of clamps (not shown in the present view for purposes of clarity), which retain one or more tubes within body 702 and maintain the tube(s) at a common voltage (e.g., ground). As shown in FIG. 7, a single tube 712 is retained in a tube passage 714 of body 702. Orbital welder 700 operates similarly to orbital welder 300 of FIG. 3.

Orbital welder 700 also includes an alignment system 718, which facilitates proper alignment of tube 712 (and a second tube to be welded to tube 712) within tube passage 714. Alignment system 718 includes a light source 720 and a light detector 722, which are both enclosed within an alignment package 724. Alignment system 718 also includes an indicator 726 for indicating the intensity of light detected by light detector 722. Alignment system 718 operates substantially similar to alignment system 318 of FIG. 3.

Orbital welder 700 also includes a mount 728, which is coupled to body 702 adjacent window 703. Alignment package 724 is coupled to mount 728 by methods similar to those described above with respect to FIG. 3. Additionally, alignment package 724 is shown in phantom, because mount 728 completely encases alignment package 724. Although not explicitly shown, alignment package 724 is adjustable using methods similar to those disclosed in the embodiment of FIG. 3.

This embodiment provides several advantages, but at least one disadvantage. First, by mounting alignment system 718 adjacent window 703 in body 702, passages through the body 702 and rotor 704 (e.g., passage 332 through body 302 and slot 334 through rotor 304), which would otherwise need to be formed, are not required. In addition, orbital welder is a more compact unit, than orbital welder 300. Further, alignment system 718 can be adapted to mount to hinges and latches (not shown) that are provided in conventional orbital welders for a hinged window cover. The primary disadvantage of orbital welder 700 is that alignment system 718 blocks window 703, thereby hindering the view of the operator into tube passage 714. However, alignment system 718, as well as alignment system 318, eliminates the need to visually align tubes, and it is expected that welders will become comfortable with and readily accept this embodiment once its reliability is demonstrated.

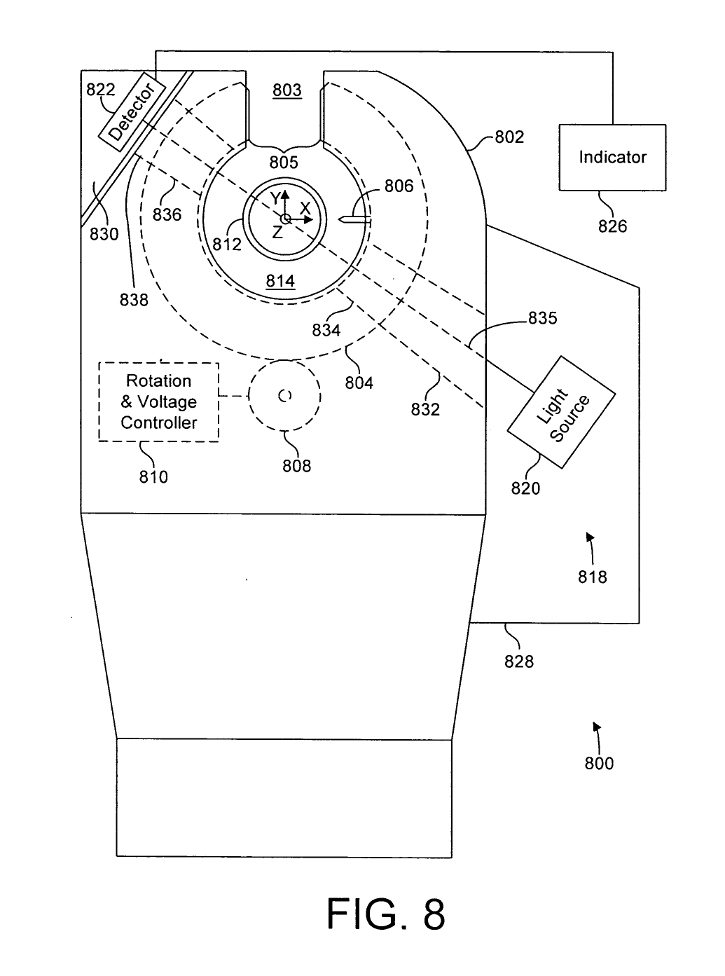

FIG. 8 shows a top view of an orbital welder 800 including an alternate alignment system 818 of the present invention. Orbital welder 800 includes an insulating body 802 defining a window 803 there through, a sectioned rotor 804 having an open section 805, a weld tip 806, a drive mechanism 808, and a rotation and voltage controller 810. Orbital welder 800 also includes a plurality of clamps (not shown in the present view for purposes of clarity), which retain one or more tubes within body 802, in addition to maintaining the tube(s) at a common voltage (e.g., ground). As shown in FIG. 8, a single tube 812 is retained in a tube passage 814 of body 802. Orbital welder 800 operates similarly to orbital welder 300 of FIG. 3.

Alignment system 818 facilitates proper alignment of tube 812 (and a second tube to be welded to tube 812) within tube passage 814 and includes a light source 820, a light detector 822, and an indicator 826 for indicating the intensity of light detected by light detector 822. Light source 820 and light detector 822 are each coupled to body 802 via one of mounts 828 and 830, respectively. Alignment system 818 operates similarly to alignment system 318 of FIG. 3, except that light detector 822 detects the intensity of light that is transmitted past tube 812, rather than reflected off of the tube as in alignment system 318.

Alignment system 818 operates as follows. Light source 820 emits light through a passage 832 formed in body 802 and a slot 834 formed through one side of rotor 804 (both shown in phantom) along light path 835. Some of the light emitted by light source 820 impinges on tube 812 in tube passage 814, while the remaining light not impinging on tube 812 passes by tube 812 and travels through a second slot 836 in the other side of rotor 804 and through a second passage 838 formed through body 802, before impinging on light detector 822. Light detector 822 monitors the intensity of light received from tube passage 314, through passages 836 and 838, and provides a signal to indicator 826 indicative of the monitored intensity. Indicator 826 displays the monitored intensity to an operator of orbital welder 800. When a predetermined intensity of detected light is received by detector 822 the operator of welder 800 knows tube 812 is properly aligned in tube passage 814.

The intensity values indicative of proper tube alignment with alignment system 818 are roughly inverted as compared to those described with reference to FIG. 6C above. For example, when no light is impinging on tube 812, approximately 95% or more of the maximum transmittance 820 will be detected by detector 822. In contrast, when tube 812 is inserted too far into tube passage 814, such that all the emitted light impinges thereon, light detector 822 will detect approximately 5% or less of the maximum transmittance. If tube 812 is properly aligned within tube passage 814 (e.g., has just broken the X-Y plane), then the intensity of the transmitted light detected by detector 822 will be approximately 50% (±2.5%) of the maximum transmittance. When, a second tube is placed in tube passage 814 and properly aligned with tube 812, the intensity of transmitted light monitored by detector 822 will be approximately 20% (±2.5%) of the maximum transmittance. Similar to the reflective system described with reference to FIGS. 3-7, when the second tube placed in tube passage 814 is rotated, any deviation in the monitored intensity value greater than (±20%) of the value indicative of proper alignment of two tubes (e.g., 20%) will indicate that tube 812, or the second tube placed in tube passage 814 is out-of-round or skewed within tube passage 814.

In the present embodiment, mounts 828 and 830 are simple brackets formed from sheet metal, and are attached to body 802 with fasteners (not shown), similar to the manner in which mount 328 is shown attached to body 302 in FIG. 4. Depending on the requirements of light source 820 and light detector 822, mounts 828 and 830 can include portions to encase light source 820 and detector 822 to protect against interference from ambient lighting. It should also be noted that a portion of body 802 is flat to allow easy attachment of mount 830 thereto.

As shown in the present embodiment, both light source 820 and light detector 822 are fixed to the outside of body 802 via mounts 828 and 830, respectively. However, it is anticipated that in future production of orbital welder 800, both light source 820 and light detector 822 will be permanently placed within body 802, with any adjustment features for adjusting either light source 820 or light detector 822 accessible to the operator outside of body 802 (e.g., via adjustment levers, an electronic interface panel, etc.).

It should also be noted that the particular placement of light source 820 and light detector 822 can be altered as required to accommodate other elements (e.g., drive gears) of welder 800. For example, light source 820 and detector 822 can be moved depending on the geometry of body 802. As another example, detector 822 could be mounted within the inner circumference of rotor 804 opposite light source 820, thereby eliminating the need for second slot 836 in rotor 804, and second passage 838 through body 802.

Light source 820 can also be configured to emit a single beam of light or emit a plurality of beams of light. While multiple alignment specifications can be detecting using a single light beam, using a plurality of light beams would more readily indicate the nature of tube misalignment. For instance, by employing a light source 820 that projects a plurality of parallel light beams in a plane parallel to the Z-axis, one could monitor the progression of the mating end of a tube, as it is being inserted into tube passage 814, toward weld tip 806. As another example, a plurality of parallel beams in the X-Y plane would be useful to monitor the planarity of the end of a tube.

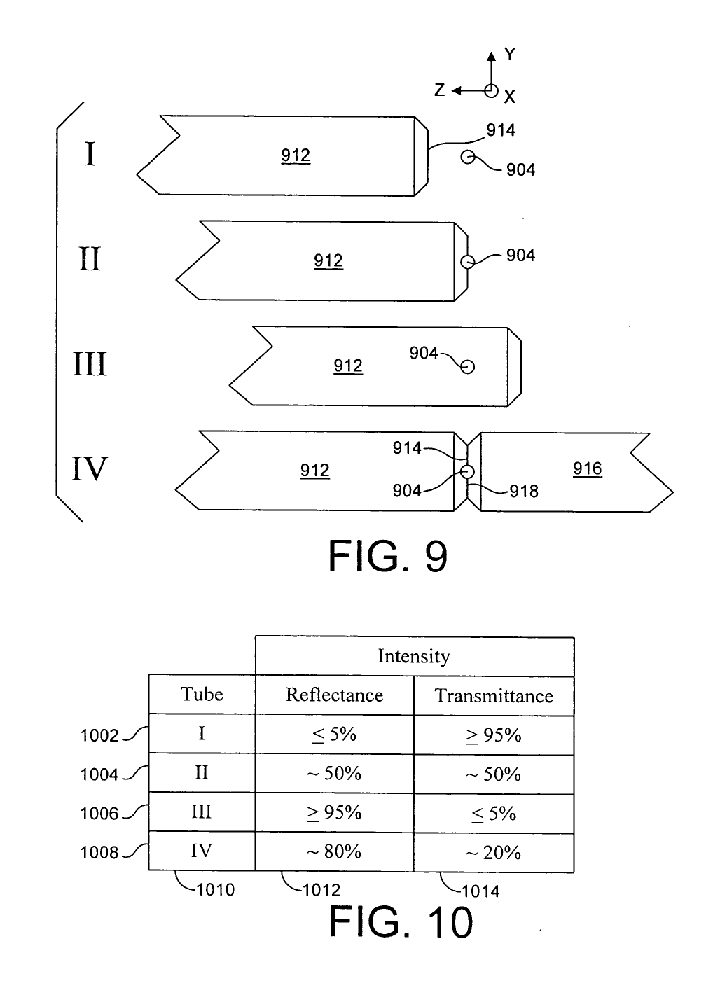

FIG. 9 shows a tube 912 in three different positions (I-III) with respect to an emitted light beam 904, and abutting another tube 916 (IV). Light beam 904 is focused to intersect the X-Y plane at the same position that a mating end 914 of tube 912 should intersect the X-Y plane.

In the first position (I), tube 912 has not been inserted far enough for light beam 904 to impinge upon it, nor for mating end 914 to be aligned with the weld tip. Thus, there will be minimum reflectance and maximum transmittance. In the second position (II), tube 912 has been inserted half way into light beam 904, and is therefore aligned with the weld tip. In this position, there will be approximately 50% of maximum reflectance and transmittance. In the third position (III), tube 912 has been inserted past light beam 904 and therefore, past the weld tip. In this position, there will be maximum reflectance and minimum transmittance. In the fourth position (IV), tube 912 and second tube 916 are both positioned half way into light beam 904. In position (IV) tube 912 and second tube 916 are aligned and ready to be welded together. In this position, there should be roughly 80% of maximum reflectance and roughly 20% of maximum transmittance.

FIG. 10 shows a table 1000 having a plurality of rows 1002, 1004, 1006, and 1008, and a plurality of columns 1010, 1012, and 1014. Rows 1002, 1004, 1006, and 1008 correspond to position (I) through position (IV) of FIG. 9, respectively. Column 1010 identifies the position number (I-IV) of tube 912 with respect to light beam 904. Column 1012 displays percentage values of reflected light monitored by a detector (e.g., light detector 322) for each tube position in an orbital welder incorporating a reflective alignment system of the present invention. Column 1014 displays percentage values of transmitted light monitored by a detector (e.g., light detector 822) for each tube position in an orbital welder incorporating a transmissive alignment system of the present invention.

The intensity percentages for each tube are as follows. For a tube in position (I), a detector adapted to detect light reflecting off tube 912 would detect approximately 5% or less of the maximum reflectance, because light beam 904 is not impinging upon tube 912. In contrast, in a transmissive system, 95% or more of the maximum transmittance would be detected. If tube 912 is position (II), then in both a reflective and transmissive system, approximately 50% of the respective maximum reflectance and maximum transmittance would be detected, because approximately half of light beam 904 is impinging on tube 912. When tube 912 is in position (III), 95% or greater of the maximum reflectance is detected in a reflective system, while approximately 5% of the maximum transmittance is detected in a transmissive system, due to light beam 904 totally impinging on tube 912. In position (IV), when mating end 914 of tube 912 is aligned and abutted with a mating end 918 of second tube 916, and light beam 904 is impinging on the seam formed between tube 912 and second tube 916, approximately 80% of the maximum reflectance will be detected in a reflective system, and approximately 20% of the maximum transmittance will be detected in a transmissive system.

One might notice some abnormalities in intensity and reflectance values shown in table 1000. For instance, for a tube in position (I), one might expect that no light would be reflected back to the detector in a reflective system, or that in a transmissive system all the light would be detectable. The slight deviations from these ideal values are caused by interference of the light with the orbital welder. For instance, for a tube in position (I), a portion of light beam 904 might be scattered in tube passage 314 of body 302, or slot 334 in rotor 304, thereby becoming detectable in the reflective case, or undetectable in the transmissive case. Similarly, with position (IV), although all of light beam 904 is impinging on the seam between tube 912 and second tube 916, some of the light may be transmitted through the seam, or reflected off the beveled mating ends 914 and 918 of tubes 912 and 916. Further, the reflectance of light off of tubes 912 and 916 will depend on the material and surface condition of tubes 912 and 916.

Accordingly, depending on the particular setup of the orbital welder and alignment system, deviation from the percentages provided as examples in table 100 is expected, and values corresponding to the tube positions shown in FIG. 9 and others will be established during the calibration and setup of the orbital welder and alignment system.

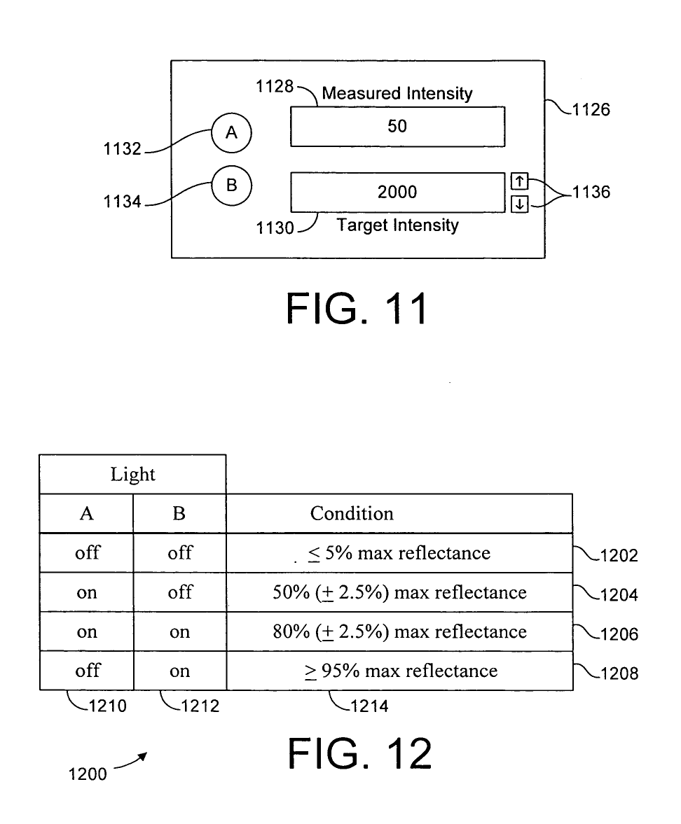

FIG. 11 shows an indicator 1126 for use with an orbital welder of the present invention. Indicator 1126 is one possible embodiment of indicator 326 (FIG. 3), indicator 726 (FIG. 7), or indicator 826 (FIG. 8). Indicator 1126 includes a measured intensity field 1128, a target intensity field 1130, a first indicator light 1132, a second indicator light 1134, and a plurality of selector keys 1136.

The components of indicator 1126 function as follows. Measured intensity field 1128 displays the intensity of light monitored by a light detector (e.g., one of light detectors 322, 722, and 822). Target intensity field 1130 displays a target intensity indicative of proper alignment of one or more tubes within a tube passage of an orbital welder of the present invention. An operator of the orbital welder is able to input or select target intensity values by using selector keys 1136. Finally, indicator lights 1132 and 1134 function as a two-bit visual indicator of the state of alignment of one or more tubes in the orbital welder. The specific operation of indicator lights 1132 and 1134 will be described hereinafter.

However, one should note that indicator 1126 is exemplary in nature, and it should be understood that various modifications to indicator 1126 are possible. For example, although indicator 1126 is shown in FIGS. 3, 7, and 8 as detached from the orbital welders of the present invention, indicator 1126 could be incorporated in the body of the orbital welder. As another example, indicator 1126 could include a keypad to enter intensity data, or a connector for connecting the indicator to an external device, such as a computer to enter or monitor intensity data. As yet another example, indicator 1126 could be fitted with a bar monitor to display the measured intensity value with respect to the target intensity value. As yet another example, monitor 1126 can be provided with calibration programming and an I/O device to enable indicator 26 to capture and store calibration values (e.g., maximum reflectance, maximum transmittance, minimum reflectance, minimum transmittance, reflectance and/or transmittance percentages for properly aligned standards, etc.).

FIG. 12 shows a table 1200 describing a 2-bit lighting scheme for indicator lights 1132 and 1134 of indicator 1126. Table 1200 includes a plurality of rows 1202, 1204, 1206, and 1208, each associated with a respective one of four different lighting modes of indicator lights 1132 and 1134. Table 1200 also includes a plurality of columns 1210, 1212, and 1214. Column 1210 displays, for each of rows 1202 through 1208, whether or not indicator light “A” 1132 is “on” or “off.” Similarly, column 1212 displays, for each of rows 1202 through 1208, whether or not indicator light “B” 1134 is “on” or “off.” Finally, column 1214 displays a plurality of conditions (percentage of maximum reflectance detected), each associated with one of rows 1202-1208, and an associated lighting mode of indicator lights 1132 and 1134.

Row 1202 corresponds to a first lighting mode in which lights “A” 1132 and “B” 1134 are both off. When both of indicator lights 1132 and 1134 are off, 5% or less of the maximum reflectance is being received by the light detector (e.g., light detector 322). The first indicator mode associated with row 1202 is indicative of no tube (e.g., tube 312) being inserted in the tube passage (e.g., tube passage 314) of the orbital welder (e.g., orbital welder 300), or the tube not being inserted far enough into the tube passage for light to impinge upon it.

Row 1204 corresponds to a second lighting mode in which light “A” 1132 is on and light “B” 1134 is off. When indicator light 1132 is illuminated and indicator light 1134 is off, approximately 50% (e.g., 50%±2.5%) of the maximum reflectance is being received by the light detector. This lighting mode is indicative of a mating end of a tube properly aligned with a weld tip (e.g., weld tip 306) of the orbital welder.

Row 1206 corresponds to a third lighting mode in which lights “A” 1132 and “B” 1134 are on. When both of indicator lights 1132 and 1134 are on, more than 64% (e.g., 80%-16%) of the maximum reflectance is being received by the light detector. This lighting mode is indicative of the mating end of a second tube (e.g., tube 612) abutting the mating end of the first tube in the tube passage.

Finally, row 1208 corresponds to a fourth lighting mode in which light “A” 1132 is off and light “B” 1134 is on. When indicator light 1132 is off and indicator light 1134 is on, 95% or more of the maximum reflectance is being received by the light detector. The lighting mode associated with row 1208 is indicative of a tube being inserted too far into the tube passage (e.g., past the weld tip), or a seam of two tubes not aligned with the weld tip.

As discussed previously, rotating the second tube when abutted with the first tube and monitoring the detected intensity will determine if one of the tubes is out-of-round, or skewed within the tube passage. The present lighting scheme indicates (e.g., by a mode change or by a separate indicator light not shown) that one of the tubes is out-of-round if the detected intensity deviates by more than 15% of the maximum reflectance when one of the tubes is rotated. As discussed above with respect to FIG. 6C, a detected intensity of 80% (±2.5%) of the emitted intensity is indicative of proper alignment of a pair of tubes. Accordingly, the lighting scheme will indicate whether or not the detected intensity remains within the range of 65%-95% of maximum reflectance.

As an example, the operator of orbital welder 300 would use the lighting scheme shown in table 1200 in conjunction with indicator 1126 to align tube 312 and second tube 612 within tube passage 314 as follows. After powering and initializing orbital welder 300 and alignment system 318, the operator of welder 300 slowly inserts tube 312 into tube passage 314 until light “A” 1132 illuminates. Once light “A” 1132 is on, the operator clamps tube 312 in place by engaging clamp 408, making sure light “A” 1132 remains on. Next, the operator inserts second tube 612 into tube passage 314 and abuts the mating end of tube 612 with the mating end of tube 312. If the alignment of second tube 612 with tube 312 is within the acceptable range (e.g., 80%±2.5%), then light “B” 1134 will illuminate. If light “B” 1134 does not illuminate, then first tube 312 and/or second tube 612 must be adjusted, refaced, or replaced with a new tube. Next, the operator would “soft clamp” second tube 612 with clamp 410 such that second tube 612 is retained in position, but can still rotate. The operator would then rotate second tube 612. If the detected reflectance departs the range 65%-95% (as indicated by a light mode change or a separate indicator light), then second tube 612 (or possibly tube 312) must be adjusted or replaced, because second tube 612 (or tube 312) is out of round or skewed in tube passage 314. If no such deviation occurs, the operator can permanently clamp second tube 612 with clamp 410 and energize orbital welder 300 such that tube 312 and second tube 612 are welded together.

It should be noted that although the lighting scheme described in FIG. 12 is for a reflective alignment system such as the embodiments shown in FIGS. 3-7, the lighting scheme of FIG. 12 could easily be adjusted for transmissive alignment systems such as the embodiment shown in FIG. 8.

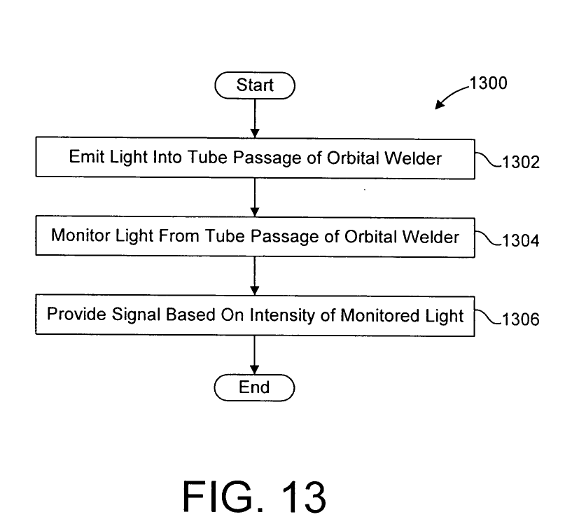

FIG. 13 is a flowchart summarizing one method 1300 for providing a signal used to align one or more tubes in an orbital welder according to the present invention. In a first step 1302, light is emitted from light source 320 into tube passage 314. Then, in a second step 1304, light is monitored from tube passage 314 by light detector 322. Finally, in a third step 1306, indicator 326 provides a signal based on the intensity of light monitored from tube passage 314 by light detector 322.

The signal provided by indicator 326 is indicative of a tube's position within tube passage 314. For instance, a signal could be provided if the monitored intensity is indicative of no tube in tube passage 314. A signal could also be provided if the monitored intensity is indicative of the end of tube 312 being inserted past the weld tip 306 and/or the end of tube 312 being aligned with weld tip 306. As other examples, a signal could be provided if the monitored intensity is indicative the end of tube 312 not lying in the same plane as the plane weld tip 306 circumnavigates, or if the monitored intensity is indicative of the end of tube 312 being out-of-round. The example signals provided are not intended to be exhaustive list of possible signals.

Although method 1300 is described with reference to the elements of FIG. 3, method 1300 is equally applicable to the alternate embodiments of the invention described in FIGS. 7 and 8 and, indeed, any orbital welder capable of performing the steps of method 1300.

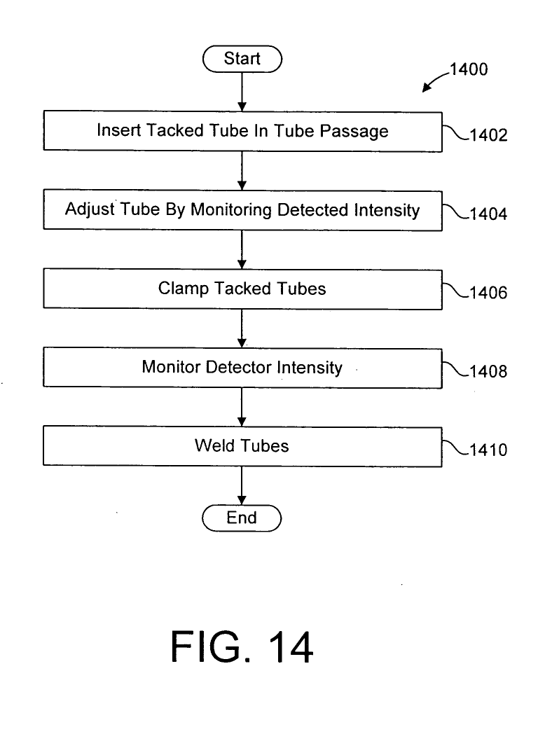

FIG. 14 is a flowchart summarizing one method 1400 of using an orbital welder (e.g., orbital welder 300) of the present invention to weld a pair of pre-tacked tubes together. In a first step 1402, an operator inserts a pre-tacked tube into tube passage 314 of orbital welder 300. In a second step 1404, the welder monitors the intensity of light detected by detector 322 via indicator 326, until the proper intensity (e.g., 80%±2.5% of the emitted intensity) is detected, thereby indicating that the seam of the pre-tacked tubes is properly aligned with weld tip 306. Then, in a third step 1406, the welder clamps the tubes in place by engaging clamps 408 and 410. In fourth step 1408, the welder monitors the intensity of detected light from detector 322, via indicator 326, to make sure that the process of clamping the tubes in place in step 1406 did not create any misalignment of the tube in tube passage 314. Finally, in a fifth step 1410, the operator welds the pre-tacked tubes together by initiating a welding routine of orbital welder 300 to arc-weld the seam of the pre-tacked tubes.

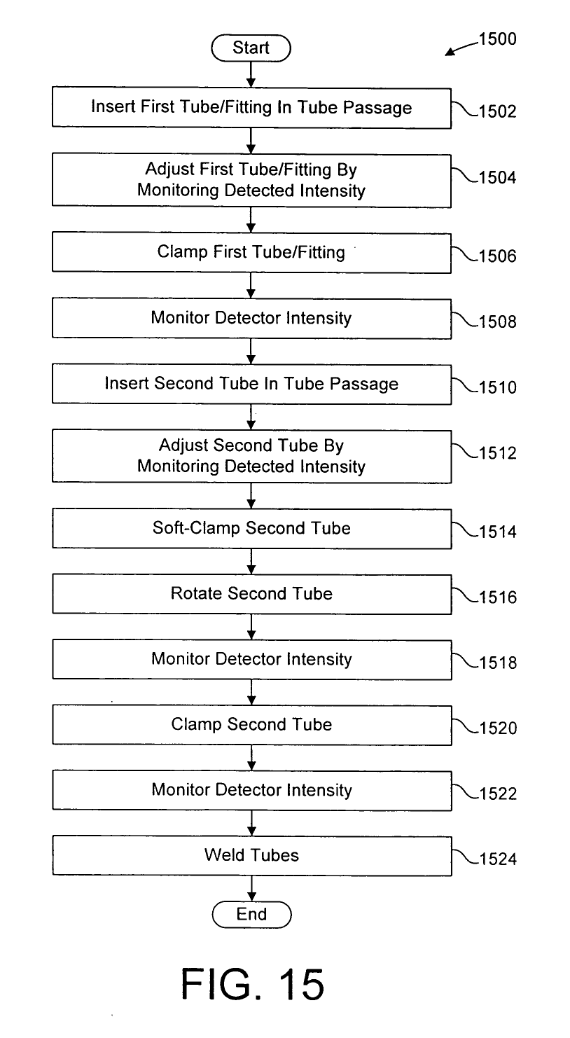

FIG. 15 is a flowchart summarizing one method 1500 for welding two tubes together using an orbital welder (e.g., orbital welder 300) of the present invention. In a first step 1502, an operator of orbital welder 300 inserts a first tube 312 (or optionally a tube fitting) into tube passage 314. Then, in a second step 1504, the operator of orbital welder 300 adjusts tube 312 (or the fitting) within tube passage 314 and monitors indicator 326 until indicator 326 indicates that the intensity of light detected by detector 322 is indicative of proper alignment of tube 312 within tube passage 314 (e.g., 50%±2.5% of the maximum reflectance). After tube 312 is aligned, in a third step 1506, the operator engages clamp 408 to retain tube 312 in position. Then, in a fourth step 1508, the operator again monitors the intensity of reflected light monitored by detector 322, via indicator 326, to ensure that the clamping process did not jar tube 312 out of alignment. In a fifth step 1510, the operator inserts second tube 612 into tube passage 314. To ensure proper alignment, in a sixth step 1512, the operator monitors the detected intensity of light received by detector 322 via indicator 326 until the intensity is indicative of the mating end of second tube 612 abutting the mating end of tube 312, thereby forming seam 614. In a seventh step 1514, the operator can “soft-clamp” second tube 612 using clamp 410, such that second tube 612 is retained in position, but can still be rotated. Then, in an eighth step 1516, the operator of welder 300 rotates second tube 612, and in a ninth step 1518, monitors indicator 326 to ensure that the monitored intensity does not deviate beyond a specified range (e.g., 65%-95%) of the maximum reflectance). Note that eighth step 1516 and ninth step 1518 can occur generally simultaneously, or sequentially. If, while rotating second tube 612, the monitored intensity did not deviate from the specified range, the operator fixes second tube 614 in place by completely engaging second clamp 410 in a tenth step 1520. Next, in an eleventh step 1522, the operator again monitors the intensity of reflected light received by detector 322 via indicator 326, to ensure that engaging clamp 410 did not misalign second tube 612. If second tube 612 is still aligned, then in a twelfth step 1524, the operator initiates a welding process of orbital welder 300 to create an arc weld around seam 614 of tube 312 and second tube 612.

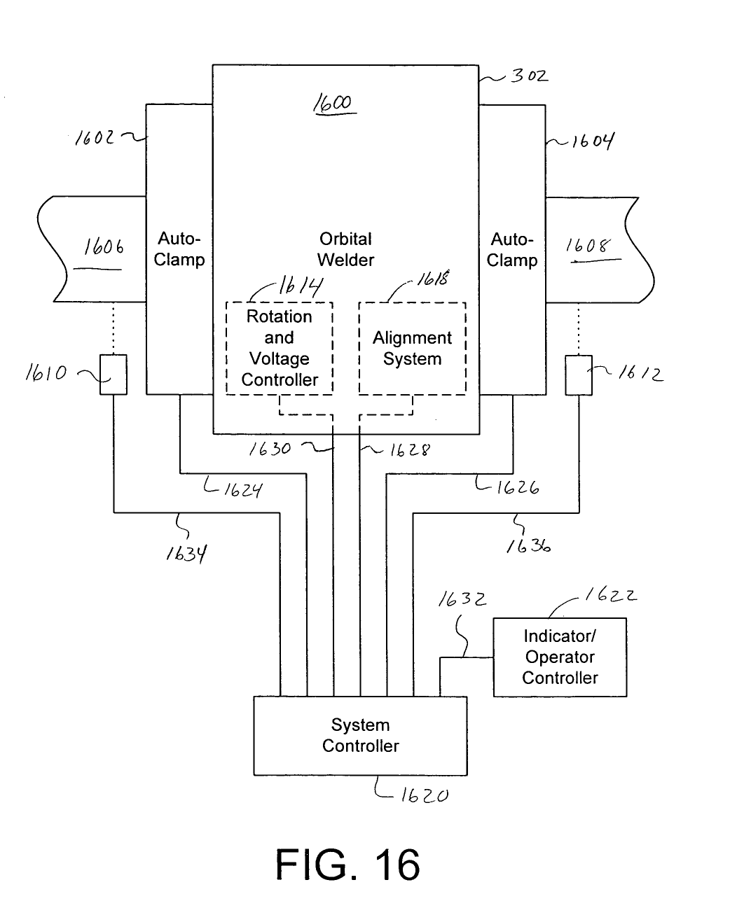

FIG. 16 shows an orbital welder 1600 including an automatic clamping system of the present invention. In the present embodiment, orbital welder 1600 includes many features of orbital welder 300 shown in FIG. 3. Therefore, these features of orbital welder 1600 that are similar to the corresponding features of orbital welder 300 will be referenced by the indices given those features in FIG. 3.

Orbital welder 1600 includes a first automatic clamp 1602 disposed adjacent its tube passage 314 on one side of its body 302, and a second automatic clamp 1604 disposed adjacent the tube passage on the other side of its body 302. Auto-clamp 1602 automatically engages a first tube 1606 when a mating end of tube 1606 is aligned with respect to the weld tip 306 of orbital welder 1600. Similarly, auto-clamp 1604 automatically engages a second tube 1608 when a mating end of tube 1608 is aligned with respect to both the weld tip 306 of orbital welder 1600 and the mating end of first tube 1606. Auto-clamps 1602 and 1604 are coupled to or near the body of orbital welder 1600 using methods known in the art, for example, via fasteners. Optionally, auto-clamps 1602 and 1604 can be positioned away from the body of orbital welder 1600 and/or be supported by additional structural devices (e.g., a support frame) and mounting hardware.

To detect the presence of tubes 1606 and 1608, orbital welder 1600 includes a first tube detector 1610 and a second tube detector 1612, respectively. In the present embodiment, tube detectors 1610 and 1612 are optical sensors that emit an optical beam perpendicular to the longitudinal axis of tubes 1606 and 1608, respectively. When the optical beam of one of tube detectors 1610 and/or 1612 is interrupted, the tube detector 1610 and/or 1612 provides a signal indicating the presence of the respective one of tubes 1606 and 1608.

Orbital welder 1600 also includes a rotation and voltage controller 1614 and an alignment system 1618. Rotation and voltage controller 1614 and alignment system 1618 perform the same functions as rotation and voltage controller 310 and alignment system 318 of FIG. 3, respectively, in addition to the functions described below. In the present embodiment, rotation and voltage controller 1614 and alignment system 1618 are shown to interface directly with a system controller 1620. It should be noted that rotation and voltage controller 1614 is shown only representationally as part of orbital welder 1600, and could be separately connected to orbital welder 1600 as a separate component. It should also be noted that alignment system 1618 can function like any of the alignment systems described in the present invention, for example, alignment systems 718 and 818 and orbital welder 1600 would include the necessary modifications to incorporate those alignment systems.

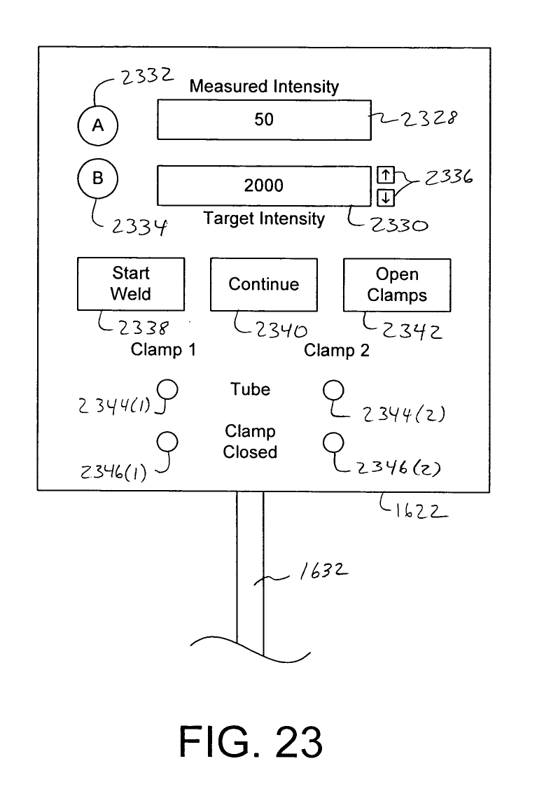

Orbital welder 1600 also includes a combination indicator and operator controller (IOC) 1622. IOC 1622 can perform the functions of any of the indicators (326, 726, 826, 1126) described previously herein. In addition, IOC 1622 includes operator controller functions that permit an operator of orbital welder 1600 to have control over the clamping and welding processes. For example IOC 1622 could permit an operator of welder 1600 to start the welding process. As another example, IOC 1622 could facilitate the release of one or both of auto-clamps 1602 and 1604. Indeed, operator controller 1622 could provide any indication or control interface to an operator of welder 1600 deemed necessary. Finally, the indicator and controller functions of IOC 1622 could be embodied in separate controllers. IOC 1622 is described in greater detail in FIG. 23.

Orbital welder 1600 further includes a system controller 1620 that monitors, controls, and coordinates the operations of the various components of orbital welder 1600. Accordingly, system controller 1620 is coupled to auto-clamp 1602 via a first clamp control line 1624 and to auto-clamp 1604 via a second clamp control line 1626. System controller 1620 sends close signals to clamps 1602 and 1604 via clamp control lines 1624 and 1626 depending on the alignment of tubes 1606 and 1608, respectively. In addition, system controller 1620 monitors signals received from alignment system 1618 (e.g., the intensity of detected light) via an intensity signal line 1628. System controller 1620 sends control signals to rotation and voltage controller 1614 via a weld signal line 1630 for causing rotation and voltage controller 1614 to energize the weld tip (see FIG. 3) of orbital welder 1600 and to weld tubes 1606 and 1608 together. In addition, system controller 1620 sends alignment intensity information to and receives operator instructions from IOC 1622 via an IOC signal line 1632. Finally, system controller 1620 receives tube detection signals from tube detectors 1606 and 1608 via tube detector lines 1634 and 1636, respectively, to indicate the presence of tubes 1606 and/or 1608.

The components of orbital welder 1600 function as follows. Initially, no tubes are placed in orbital welder 1600, auto-clamps 1602 and 1604 are open and ready to accept tubes therein, alignment system 1618 is powered and is providing an intensity signal indicative of the intensity of detected light to system controller 1620, and system controller 1620 is relaying detected intensity information to IOC 1622. Because no tubes have yet been placed in orbital welder 1600, both of tube detectors 1606 and 1608 are indicating that no tubes are present to system controller 1620.

Next first tube 1606 is inserted into the clamping passage of auto-clamp 1602 and is “soft-clamped” by the operator of orbital welder 1600, by closing the jaw of clamp 1602 around tube 1606. Soft-clamping tube 1606 ensures that tube 1606 is securely retained in clamp 1602, but can still be manipulated and moved. Tube detector 1610 indicates the presence of tube 1606 to system controller 1620 by asserting a signal (e.g., a digital HIGH value) on tube detection line 1634. As tube 1606 is inserted into the tube passage (FIG. 3) of orbital welder 1600, alignment system 1618 begins to detect that the mating end (FIG. 4) of tube 1606 is nearing alignment with the weld tip. Accordingly, alignment system 1618 is transmitting an intensity signal to system controller 1620 indicative of the alignment of the mating end of tube 1606 with respect to the weld tip. When the mating end of tube 1606 is aligned with the weld tip, system controller 1620 instructs auto-clamp 1602 to close on tube 1606, and retain tube 1606 in position.

System controller 1620 is responsive to the intensity of light detected by alignment system 1618, and operative at a first predetermined intensity of detected light to cause auto-clamp 1602 to close and secure tube 1606. For example, as described above with respect to FIG. 6C and FIG. 8, for both a reflective and a transmissive system, when the detected intensity of light is equal to 50% (±2.5%) of the maximum reflectance or transmittance value, the mating end of tube 1606 is aligned with the weld tip of orbital welder 1600. Accordingly, responsive to system controller 1620 receiving a signal from alignment system 1618 indicative of the detected intensity being 50% (±2.5%) of the maximum detectable reflectance or transmittance, system controller 1620 is operative to close auto-clamp 1602 by generating a close signal to auto-clamp 1602 via clamp control line 1624.

After auto-clamp 1602 is engaged, second tube 1608 is inserted into auto-clamp 1604 and soft-clamped. As a result, tube detector 1612 provides a tube detection signal (e.g., a digital HIGH signal) to system controller 1620 indicating the presence of tube 1608. Tube 1608 is inserted into the tube passage of orbital welder 1600 until the mating end of second tube 1608 abuts the mating end of first tube 1606. When the mating end of second tube 1608 abuts the mating end of first tube 1606, alignment system 1618 will indicate a second predetermined intensity value indicative of proper alignment of second tube 1608 with respect to the weld tip and first tube 1606. As stated above, at least in the descriptions of FIG. 6C and FIG. 8, proper alignment of tube 1608 is indicated by a detected intensity of 80% (±2.5%) of the maximum reflectance in a reflective alignment system, and by a detected intensity of 20% (±2.5%) of the maximum transmitted intensity in a transmissive alignment system.

To check the deviation from accepted values, system controller 1620 monitors the intensity signal provided by alignment system 1618 while second tube 1608 is rotated. If system controller 1620 determines that the detected intensity deviates beyond a predetermined range from the second predetermined intensity while second tube 1608 is rotated, system controller 1620 will not permit auto-clamp 1604 to close around tube 1608. If however, second tube 1608 is rotated and the detected intensity does not deviate out of the predetermined range, then system controller 1620 will close auto-clamp 1604 around tube 1608 by generating a close signal on control line 1626. Again referring to the descriptions of FIG. 6C and FIG. 8, the inventor has found that a suitable deviation range is (±20%) of the second predetermined intensity for both reflective and transmissive alignment systems.

It is important that system controller 1620 knows when second tube 1608 has been completely rotated. Therefore, there are several methods in which system controller 1620 could close second auto-clamp 1604. In the first, system controller 1620 could close second clamp 1604 after receiving a signal from IOC 1622 via IOC signal line 1632 from the operator of orbital welder 1600 indicating that tube 1608 has been completely rotated. As another example, system controller 1620 could include a timer to permit the operator of welder 1600 ample time to rotate second tube 1608 before closing clamp 1604 automatically. As still another example, auto-clamp 1604 could include a rotation mechanism which would automatically rotate tube 1608 through a complete revolution and indicate to system controller 1620 when a tube 1608 has been completely rotated. Indeed, there are many conceivable methods for indicating to system controller 1620 that tube 1608 (or tube 1606) has been completely rotated.

Once auto-clamp 1604 is engaged, system controller 1620 instructs rotation and voltage controller 1614 (via weld signal line 1630) to energize the weld tip and weld the mating ends of tubes 1606 and 1608 together. This can be accomplished in several ways. For example, system controller 1620 can begin the weld process responsive to a signal received from an operator of welder 1600 via IOC 1622. As another example, system controller 1620 could start the weld sequence automatically, such as after an elapsed time period. It is anticipated that the welding process will be initiated by the operator via IOC 1622 in order to increase operator safety. In addition, rotation and voltage controller 1614 indicates to system controller 1620 when the weld process is complete via weld signal line 1630.

After the welding process is complete, system controller 1620 opens clamps 1602 and 1604 by providing an open signal via clamp control lines 1624 and 1626, respectively. The open signal is provided to clamps 1602 and 1604 responsive to system controller 1620 receiving open instructions from an operator of welder 1600 via IOC 1622. Optionally, system controller 1620 can generate the open signal automatically. It should be noted that open instructions can be generated at any time by IOC 1622 in order to release one or both of auto-clamps 1602 and 1604. If the open instructions are received by system controller 1620 during a welding operation, system controller 1620 instructs rotation and voltage controller 1614 to stop supplying electrical energy to the weld tip of orbital welder 1600 before opening clamps 1602 and 1604.

System controller 1620 is also able to detect the presence of a pre-tacked pair of tubes (e.g., tubes 1606 and 1608) placed in auto-clamps 1602 and 1604. System controller 1620 recognizes pre-tacked tubes 1606 and 1608 based on the tube detection signals provided thereto by tube detectors 1606 and 1608. If both of tube detectors 1606 and 1608 register the presence of a tube before either of auto-clamps 1602 and 1604 are closed about tubes 1606 and 1608, then system controller 1620 recognizes that tubes 1606 and 1608 are pre-tacked. Once pre-tacked tubes 1606 and 1608 are placed in auto-clamps 1602 and 1604, clamps 1602 and 1604 are soft-clamped. System controller 1620 then monitors the intensity of light detected by alignment system 1618 as tubes 1606 and 1608 are adjusted within orbital welder 1600 for an amount indicative of proper alignment of the seam of pre-tacked tubes 1606 and 1608 with the weld tip of orbital welder 1600. As stated above, proper alignment of a pair of pre-tacked tubes 1606 and 1608 is indicated by a detected intensity of 80% (±2.5%) of the maximum reflectance in a reflective alignment system, or by a detected intensity of 20% (±2.5%) of the maximum transmitted intensity in a transmissive alignment system. Once the target intensity is reached, any additional alignment operations can be performed (e.g., rotation of the pre-tacked tubes with both clamps 1602 and 1604 in a soft-clamp state). As long as the detected intensity does not deviate beyond a predetermined range from the target intensity, auto-clamps 1602 and 1604 are engaged around tubes 1606 and 1608 and welded together.

Although the inventor has found that alignment system 1618 is able to detect the proper alignment of all tube diameters retainable by auto-clamps 1602 and 1604 without adjustment, it may become desirable for the system controller to adjust one or more components of orbital welder 1600 based on varying tube diameters placed in auto-clamps 1602 and 1604. The reason why adjustment may be needed is recalled by referring back to FIGS. 6A-6C. As shown, the light rays 604 emitted by light source 320 are focused to impinge on tubes 312 and 612 at their beveled edges 402. The depth of focus from light source 320 to the beveled edge 402 will change depending on the diameter of the tubes 312 and 612. Accordingly, it may become necessary to adjust alignment system 1618 to compensate for large variations in tube diameter from the mean diameter that alignment system 1618 can detect accurately.

Accordingly, in a particular embodiment, orbital welder 1600 includes tube size detecting means for indicating to system controller 1620 the diameters of tubes 1606 and 1608. For example, auto-clamps 1602 and 1604 might include tube size detecting means (not shown), which enable clamps 1602 and 1604 to determine the diameters of tubes 1606 and 1608, respectively. Clamps 1602 and 1604 could then communicate the diameters of tubes 1606 and 1608 to system controller 1620 via clamp control lines 1624 and 1626, respectively. As another example, IOC 1622 could include an input that would allow an operator to input the diameter of tubes 1606 and 1608, such that system controller 1620 could make the necessary adjustments to the alignment process.

There are several ways for system controller 1620 to compensate for varying tube diameters. For example, if alignment system 1618 were a stationary system and the focal distance could not be adjusted, then system controller 1620 could automatically adjust the predetermined intensity values to which it signals clamps 1602 and 1604 to close depending on the diameter of the tubes 1606 and 1608. Such adjusted intensity values could be determined empirically. As another example, if alignment system 1618 included automated adjustment means such as those described in FIG. 3, system controller 1620 could automatically focus the light rays emitted by alignment system 1618 onto the beveled edges of tubes 1606 and 1608 by adjusting the position of alignment system 1618 with respect to tubes 1606 and 1608.

The clamping system of the present invention provides several notable advantages over the systems and methods of the prior art. Most importantly, the time required of an operator to weld tubes is greatly reduced because the alignment and clamping processes are automated. Second, the clamping process does not jar tubes out of alignment, as often happens during manual clamping, thereby significantly reducing the instances when tubes must be realigned. Third, orbital welder 1600 improves the quality and consistency of the finished product because each set of tubes is clamped with a good alignment and welded together without the tubes becoming misaligned during the clamping process. Furthermore, the learning curve of orbital welder 1600 is significantly lower than using the orbital welders and methods of the prior art. For example, a novice operator of welder 1600 would quickly and easily produce perfectly aligned pairs of welded tubes. The same novice, using welders and clamping methods of the prior art, would require much more time to consistently produce quality welds between pairs of tubes due to the drawbacks discussed in the background above.

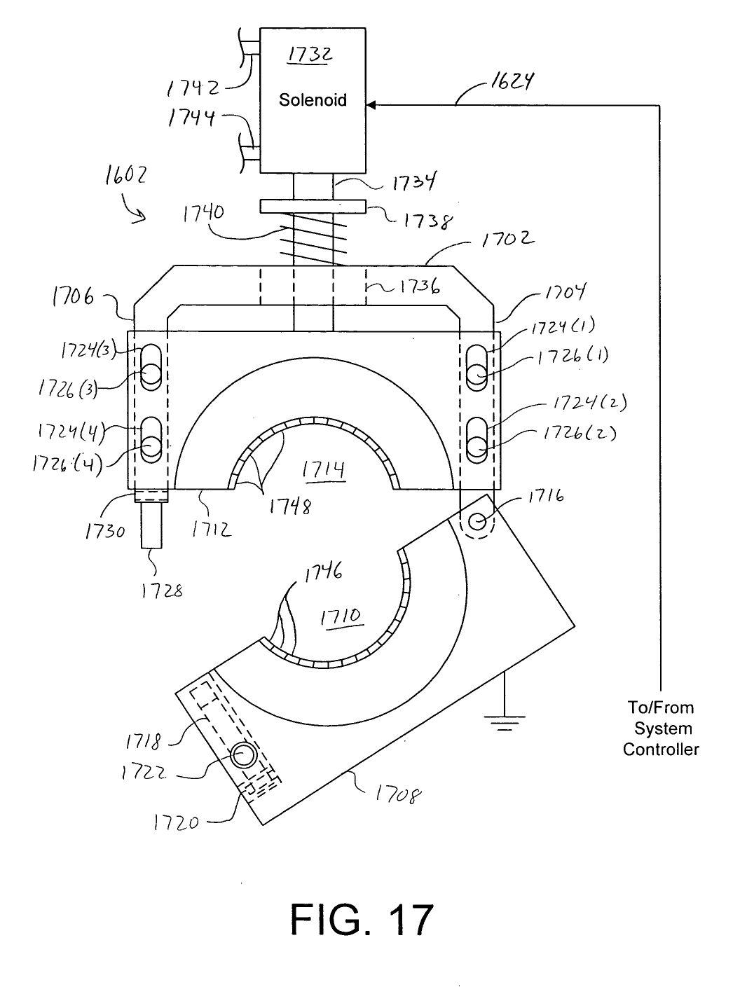

FIG. 17 is a front view of first automatic clamp 1602 in an open position. FIG. 17 will be described with reference to clamp 1602, however it should be noted that clamp 1604 is substantially similar to clamp 1602, and the following description applies equally thereto.

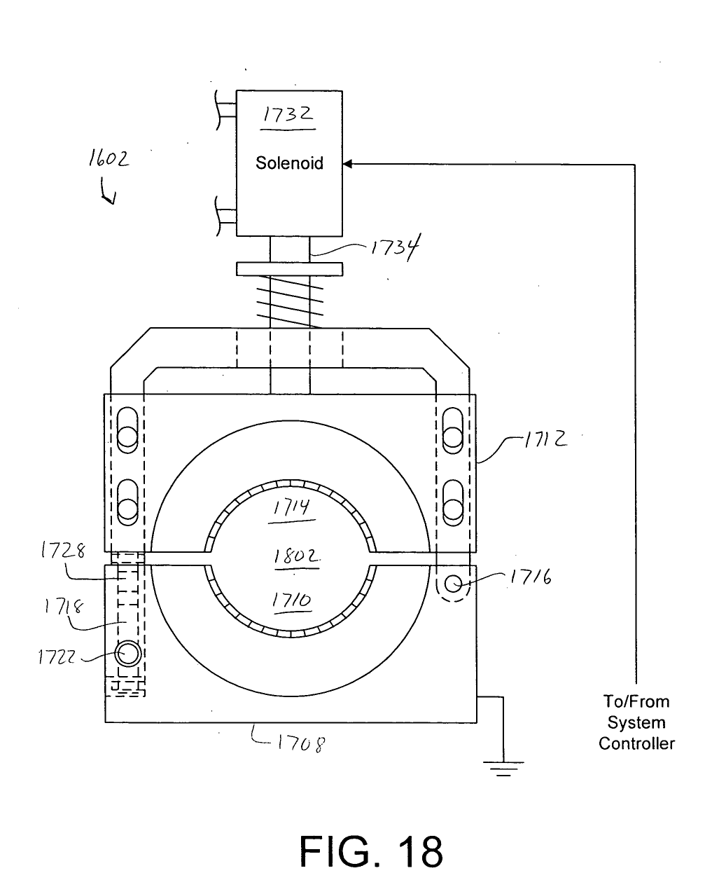

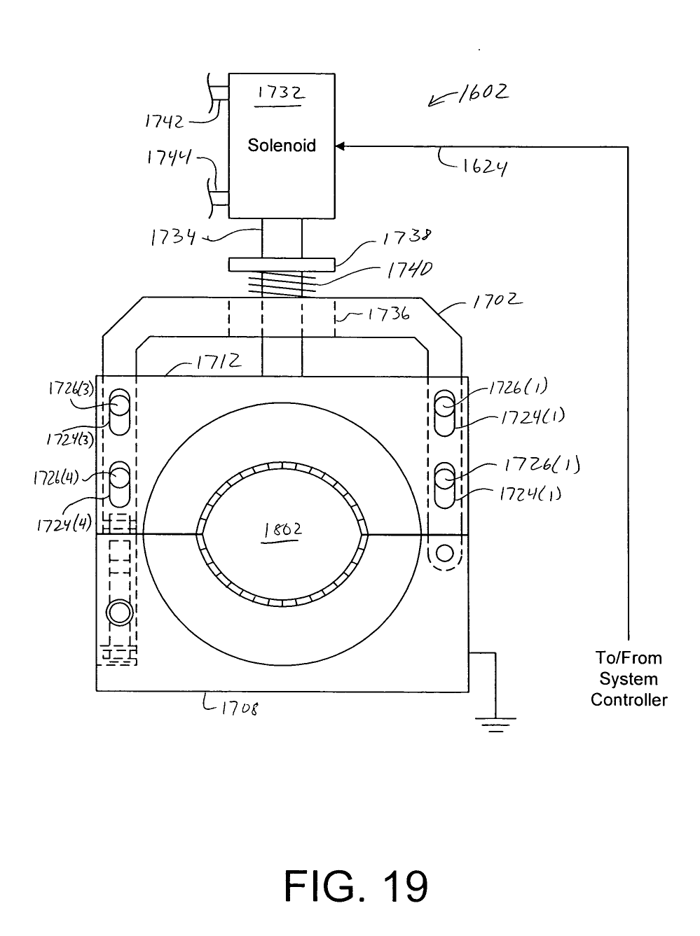

Clamp 1602 includes a frame 1702 having a first arm 1704 and a second arm 1706, a lower jaw 1708 defining a lower clamping passage 1710, and an upper jaw 1712 defining an upper clamping passage 1714 complementary to lower clamping passage 1710. It should be noted that the clamping passages 1710 and 1714 of jaws 1708 and 1712 form a single clamping passage when clamp 1602 is closed, and are semi-circular to facilitate the clamping of various sizes of tubes therebetween (FIGS. 18 and 19). At least one of jaws 1708 and 1712 is retained at a common voltage (e.g., ground) such that welding current will flow from the weld tip of orbital welder 1600, through tube 1606, and through at least one of jaws 1708 and 1712 to the common voltage source.

Lower jaw 1708 is rotatably coupled to the rounded distal end of first arm 1704 via a pin 1716. Lower jaw 1708 also includes a hook latch 1718 on the opposite side of clamping passage 1710 as pin 1716. Hook latch 1718 is retained inside the boundaries of lower jaw 1708. Hook latch 1718 is rotatably coupled to jaw 1708 via a pin 1720, such that latch 1718 can rotate into and out of the plane of the page. Lower jaw 1708 also includes a release mechanism 1722 for pushing latch 1718 into the plane of the page. Upper jaw 1712 is slidably coupled to first and second arms 1704 and 1706 of frame 1702, and is able to slide up and down with respect to lower jaw 1708. Upper jaw 1712 includes a plurality of oblong sliding notches 1724(1-4) which slidably engage a plurality of pins 1726(1-4) disposed through arms 1704 and 1706.

Second arm 1706 also includes a hook latch 1728 disposed at its distal end. Latch 1728 is rotatably coupled to second arm 1706 via a pin 1730, such that latch 1728 can rotate into and out of the plane of the page. The hook (FIG. 21) of latch 1728 is disposed to engage the hook of latch 1718 such that lower jaw 1708 can be locked in a soft-clamped position (see FIG. 18). Because lower jaw 1708 rotates between open and closed positions to facilitate the loading of tube 1606 in clamp 1602, it is anticipated that some other means (e.g., support guides, etc.) will be used to help support tube 1606, which is placed in upper clamping passage 1714 before lower jaw 1708 is latched with hook latch 1728.

Finally, clamp 1602 includes a force actuator 1732 having an extendable ram 1734. In the present embodiment, force actuator 1732 is a pneumatic solenoid. Ram 1734 is connected to the top of upper jaw 1712, such that when ram 1734 is extended, upper jaw 1712 is pushed down into a closed position with respect to lower jaw 1708 (FIG. 19). Frame 1702 includes an aperture 1736 such that ram 1734 can pass therethrough. Ram 1734 also includes a collar 1738 having a return spring 1740 disposed between collar 1738 and frame 1702. When ram 1734 is extended (i.e., moved downward), spring 1740 is compressed between collar 1738 and frame 1702. When solenoid 1732 stops applying extension force to ram 1734, then spring 1740 returns ram 1734 to the position shown.

Solenoid 1732 extends ram 1734 in response to receiving a close clamp signal (e.g., a high digital signal) via clamp control line 1624 from system controller 1620. Extension force is supplied to ram 1734 via air pressure supplied to a high-pressure air inlet 1742 of solenoid 1732. High pressure air is relieved from solenoid 1732 via an air outlet 1744.

As shown in the present embodiment both lower jaw 1708 and upper jaw 1712 include a plurality of positioning tabs 1746 and 1748 disposed about the perimeter of clamping passage 1710 and 1714, respectively. Positioning tabs 1746 and 1748 center tube 1606 with respect to clamping passages 1710 and 1714 and with respect to the tube passage and weld tip of orbital welder 1600.

FIG. 18 is a front view of auto-clamp 1602 of the present invention in a “soft-clamp” position. In the present view, lower jaw 1708 of clamp 1602 has been rotated clockwise about pin 1716 such that hook latch 1718 has engaged hook latch 1728. Because latches 1718 and 1728 are locked with each other, lower jaw 1708 cannot rotate open (e.g., counter-clockwise) without an operator disengaging latches 1718 and 1728 by actuating release mechanism 1722. Although lower jaw 1708 is in a “soft-clamp” closed position, a tube placed in a clamping passage 1802 defined by upper and lower clamping passages 1710 and 1714 can still be manipulated within clamp 1602. For example, a tube could still be moved through clamping passage 1802 (e.g., into and out of the plane of the page) and/or could be rotated by an operator of welder 1600. Also readily visible in the present figure is the oblong shape of tube passage 1802. Again, the oblong shape of tube passage 1802 allows clamp 1602 to close around tubes having a variety of diameters.

FIG. 19 is a front view of auto-clamp 1602 in a closed position. In order to close clamp 1602, solenoid 1732 has been activated to extend ram 1734 and push upper jaw 1712 toward lower jaw 1708. Solenoid 1732 is responsive to a close signal received via clamp control line 1624 from system controller 1620. Responsive to receiving the close signal, solenoid 1732 accepts high pressure air from high pressure inlet 1742 in order to extend ram 1734. As ram 1734 extends, collar 1738 compresses spring 1740 between itself and frame 1702. As ram 1734 extends, sliding notches 1724(1-4) of upper jaw 1712 slide over pins 1726(1-4) of frame 1702, such that upper jaw 1712 slides downward toward lower jaw 1708 until it presses against a tube (e.g., tube 1606) placed in clamping passage 1802. Upper jaw 1712 remains in a closed position until solenoid 1732 receives an open signal (e.g., a low digital signal) via clamp control line 1624, after which solenoid 1732 is operative to close high pressure inlet 1742 and vent to air outlet 1744. Accordingly, spring 1740 biases collar 1738 and pushes upper jaw 1712 back toward solenoid 1732, such that clamp 1602 returns to the “soft clamp” position shown in FIG. 18.

It should be noted that although a pneumatic solenoid 1732 is shown in the present embodiment, many different force actuators can be used with clamp 1602 without departing from the scope of the present invention. For example, pneumatic solenoid 1732 could comprise an electromagnetic solenoid. As another option, solenoid 1732 and ram 1734 might be replaced with an electric motor and jack-screw combination. In one case, the motor could be attached directly to the end of the jack screw, and the jack screw could be threaded through aperture 1736 in frame 1702, such that when the motor turned the jack screw, the jack screw would push upper jaw 1712 toward lower jaw 1708. In another example, the motor could include a gear to engage and turn the jack screw to cause it to advance upper jaw 1712 toward lower jaw 1708.

The force actuators described herein provide an additional advantage in that they do not jar tube 1606 in clamping passage 1802 when they close. As a result, the fine alignment of tube 1606 in clamping passage 1802 is maintained when clamp 1602 is closed, and necessary readjustments of tube 1606 (and tube 1608) are dramatically reduced. Accordingly, solenoid 1732 (and any other force actuator) is calibrated such that the closing of jaws 1708 and 1712 will not cause misalignment of the tube in orbital welder 1600.

It should also be noted that positioning clamp 1602 such that upper jaw 1712 pushes down on lower jaw 1708 is an important aspect of the present invention. When lower jaw 1708 is closed in the “soft-clamp” position shown in FIG. 18, tube 1606 is retained at proper height with respect to the weld tip and alignment system 1618 of orbital welder 1600. In this regard, stationary lower jaw 1708 supports the tube at the proper height, such that when upper jaw 1712 is moved downward toward lower jaw 1708, the height of tube 1606 does not change. This would not be the case, however, were clamp 1602 “flipped” such that lower jaw 1708 was positioned above upper jaw 1712.

Upper jaw 1712 is shown in the present view to directly abut lower jaw 1708. However, upper jaw 1712 does not need to directly abut lower jaw 1708 to properly clamp a tube in clamping passage 1802. For example, for a large diameter tube there might be some gap (e.g., less than the gap shown in FIG. 18) between lower jaw 1708 and upper jaw 1712. Despite some gap, solenoid 1732 pushes down on upper jaw 1712 with sufficient force (e.g., 50 pounds net or greater) to maintain the tube placed in clamping passage 1802 in a stationary position.

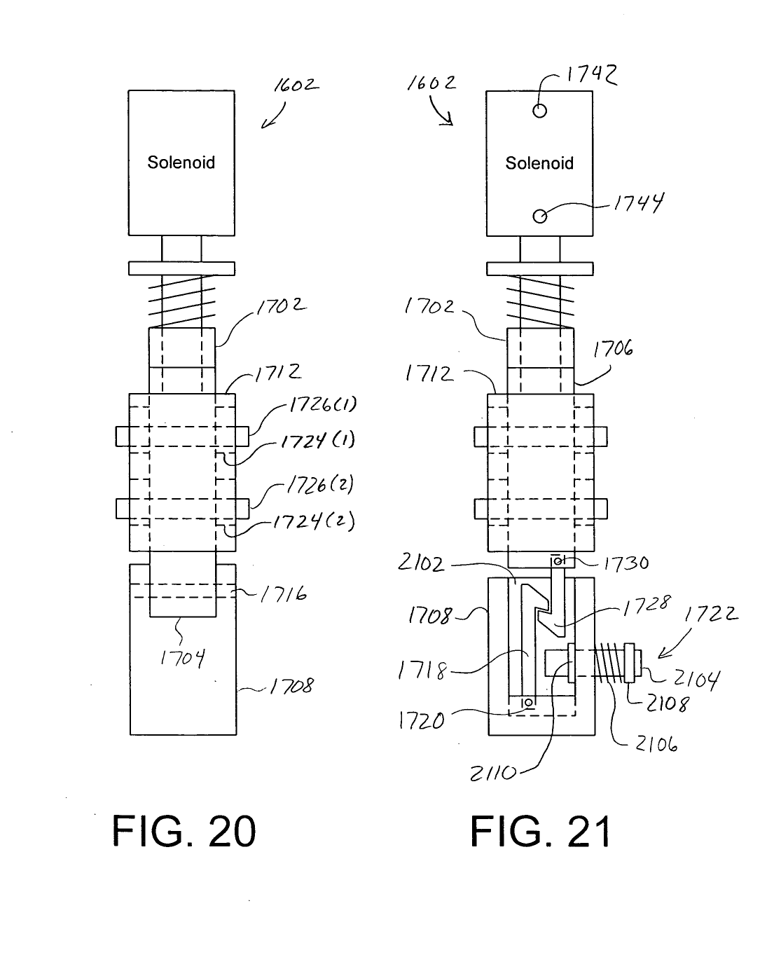

FIG. 20 is a right side view of auto-clamp 1602 in the “soft-clamp” position shown in FIG. 18. In FIG. 20, two of pins 1726(1-4) are shown to pass completely through the arms of frame 1702 and through sliding notches 1724(1-4), respectively, of upper jaw 1712. Also in FIG. 20, pin 1716 is clearly shown hinging lower jaw 1708 to the distal end of first arm 1704 of frame 1702, such that lower jaw 1708 can pivot.

FIG. 21 is a left side view of auto-clamp 1602 in the “soft-clamp” position shown in FIG. 18. In FIG. 21 hook latches 1718 and 1728 and release device 1722 are shown in greater detail. In particular, hook latch 1718 is located in a recess 2102 formed in lower jaw 1708 and pivots about pin 1720 which is passed through the side of lower jaw 1708, through the pivoting end of hook latch 1718 in recess 2102, and again into lower jaw 1708. The hook of hook latch 1718 is positioned facing the center of lower jaw 1708. Hook latch 1728 is shown pivotally connected to the lower distal end of second arm 1706 via pin 1730 driven through second arm 1706. Although not expressly shown, it is understood that second arm 1706 includes a recessed cradle for latch 1728, such that latch 1728 can rotate about pin 1730. The hook of latch 1728 is also positioned facing the center of lower jaw 1708, although hook latch 1728 is positioned opposite hook latch 1718 such that the hooks of latches 1718 and 1728 can engage one another. It should be noted that a portion of the side wall of lower jaw 1708 adjacent recess 2102 is removed to prevent interference between lower jaw 1708 and hook latch 1728 when lower jaw 1708 is rotated into the “soft-clamp” position.

Release device 1722 is disposed to push hook latch 1718 away from hook latch 1728 in order to disengage latches 1718 and 1728. Release device 1722 includes a plunger 2104 passing through the front wall of lower jaw 1708 and into recess 2102. Plunger 2104 is biased away from hook latch 1718 by a spring 2106 which is retained between the front wall of jaw 1708 and a collar 2108 fixed to plunger 2104. A second collar 2110 is fixed around plunger 2104 on the inside of recess 2102 and prevents plunger 2104 from completely withdrawing from recess 2102. When the operator of orbital welder 1600 pushes plunger 2104 in toward lower jaw 1708, the end of plunger 2104 in recess 2102 pushes latch 1718 out of engagement with latch 1728, thereby freeing lower jaw 1708 to open. Disengaging lower jaw 1708 from arm 1706 also releases tube 1606 from clamp 1602.

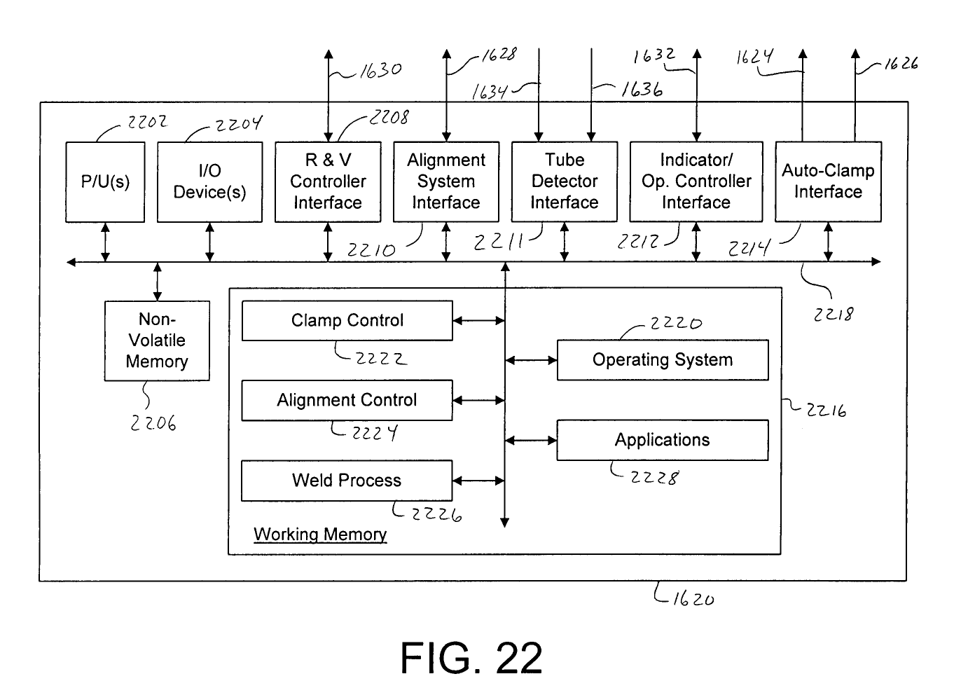

FIG. 22 shows a block system diagram of system controller 1620 according to the present invention. System controller 1620 includes one or more processing units (P/U) 2202, one or more input/output (I/O) devices 2204, non-volatile memory 2206, a rotation and voltage controller (RVC) interface 2208, an alignment system interface 2210, a tube detector interface 2211, an indicator and operator controller (IOC) interface 2212, an auto-clamp interface 2214, and working memory 2216, all interconnected via a system bus 2218.

The components of system controller 1620 perform the following functions. Processing units 2202 executes data and code stored in working memory 2216 for causing system controller 1620 to carry out its various functions (e.g., automatic clamping of tubes, welding tubes, monitoring intensity data, etc.). I/O devices 2204 facilitate interaction between a system administrator (e.g., an operator of welder 1600) and system controller 1620. I/O devices 2204 would typically include a keyboard, mouse, monitor, printer, and other such devices that facilitate communications between system controller 1620 and the administrator. Non-volatile memory 2206 (e.g. read-only memory, or one or more hard disk drives, etc.) provides storage for data and code (e.g., boot code and programs) that are retained even when system controller 1620 is powered down. Finally, system bus 2218 facilitates intercommunication between the various components of system controller 1620.

RVC interface 2208 facilitates two-way communication between system controller 1620 and rotation and voltage controller 1614. RVC interface 2208 permits system controller 1620 to transmit weld signals to rotation and voltage controller 1614 via weld signal line 1630, and receives indication that the welding process is finished.

Similarly, alignment system interface 2210 facilitates two-way communication between system controller 1620 and alignment system 1618. Alignment system interface 2210 receives intensity data from alignment system 1618 via intensity signal line 1628. Optionally, if alignment system 1618 contains adjustment means to focus alignment system 1618, system controller 1620 can also send adjustment signals to alignment system 1618 via intensity signal line 1628, or alternately a separate dedicated adjustment signal line.

Tube detector interface 2211 receives tube detection signals from tube detectors 1606 and 1608 via tube detection lines 1634 and 1636, respectively. When tube 1606 is placed in auto-clamp 1602, tube detector 1610 generates a tube detection signal (e.g., a digital HIGH signal) and transmits the tube detection signal to system controller 1620 via tube detection line 1634, where it is received by tube detector interface 2211. Likewise, When tube 1608 is placed in auto-clamp 1604, tube detector 1612 generates a tube detection signal (e.g., a digital HIGH signal) and transmits the tube detection signal to system controller 1620 via tube detection line 1636, where it is received by tube detector interface 2211.

IOC interface 2212 facilitates two-way communications between system controller 1620 and IOC 1622. IOC interface 2212 is operative to transmit intensity data to IOC 1622 and to receive operator commands from an operator of IOC 1622 via IOC signal line 1632. Although shown as only one line 1632, IOC interface signal line 1632 includes as many data lines as necessary to send and receive the various signals between system controller 1620 and IOC 1622.

Auto-clamp interface 2214 provides clamping signals to each of auto-clamps 1602 and 1604 from system controller 1620. In particular, auto clamp interface transmits a digital HIGH signal to cause auto-clamps 1602 and 1604 to close, and a digital LOW signal to cause clamps 1602 and 1604 to open. Also, if auto-clamps 1602 and 1604 included means for detecting the diameters of tubes 1606 and 1608, respectively, auto-clamp interface 2214 would function to receive diameter information from auto-clamps 1602 and 1604.

Working memory 2216 (e.g. random access memory) provides dynamic memory to system controller 1620, and includes executable code (e.g. an operating system 2220), which is loaded into working memory 2216 during system start-up. Operating system 2220 facilitates control and execution of all other modules loaded into working memory 2216. Working memory 2216 further includes a clamp control module 2222, an alignment control module 2224, a weld process module 2226, and various applications 2228 running therein. Each of the foregoing modules and programs are initialized and loaded into working memory 2216 at startup from non-volatile memory 2206 using methods well known to those skilled in the art. Optionally, the foregoing modules and programs can be loaded into working memory 2216 from alternate mass data storage devices including, but not limited to, a CD-ROM, a tape, or some other drive having sufficient storage capacity.

Clamp control module 2222 controls and coordinates the various operations of system controller 1620 and orbital welder 1600. For example, clamp control module 2222 receives tube detection signals from tube detector interface 2211. As another example, clamp control module 2222 is operative to receive an intensity signal from alignment system interface 2210 indicative of the alignment of tubes 1606 and 1608 with respect to the weld tip of orbital welder 1600. Control module 2222 is also operative to compare the received intensity signal with predetermined intensity values indicative of proper alignment of tubes 1606 and 1608 within orbital welder 1600. With respect to the alignment of second tube 1608, clamp control module 2222 also ensures that the intensity value does not deviate within a predetermined range of the second intensity value when second tube 1608 is rotated. When tubes 1606 and 1608 are properly aligned and the corresponding intensity signals are received, clamp control module 2222 is further operative to generate and send close signals to each of auto-clamps 1602 and 1604 via auto-clamp interface 2214 and clamp control lines 1624 and 1626, respectively. When generating a close signal to either of clamps 1602 and 1604, clamp control module 2222 also indicates to IOC 1622 that the clamp is closed via IOC interface 2212. After clamps 1602 and 1604 are closed, clamp control module 2222 instructs weld process module 2226 to begin the welding process of tubes 1606 and 1608. Additionally, after tubes 1606 and 1608 have been welded, clamp control module 2222 is operative to send an open signal to clamps 1602 and 1604 via auto-clamp interface 2214 and signal lines 1624 and 1626, respectively.

When generating signals to begin the welding process and to open clamps 1602 and 1604, clamp control module 2222 is responsive to the signals from an operator of welder 1600 via IOC interface 2212. For example, before starting the welding process, clamp control module 2222 waits to receive a weld signal from an operator of welder 1600 via IOC interface 2212. If a weld signal is received via IOC interface 2212, clamp control module 2222 instructs weld process module 2226 to start the welding process. In an alternate embodiment, clamp control module 2222 is operative to automatically signal weld process module 2226 to begin the weld process.

Similarly, before sending an open signal to clamps 1602 and 1604, clamp control module 2222 waits to receive an open signal via IOC interface 2212. It should be noted that clamp control module 2222 is continuously responsive to open signals received from an operator of orbital welder 1600 to open clamps 1602 and 1604, even if the welding process must be stopped. Alternately, clamp control module 2222 is operative to automatically send an open signal to clamps 1602 and 1604.

Clamp control module 2222 also recognizes the presence of a pair of pre-tacked tubes placed in auto-clamps 1602 and 1604. For example, if clamp control module 2222 receives tube detection signal from both of tube detectors 1610 and 1612 via tube detector interface 2211 before either of auto-clamps 1602 and 1604 are closed, then clamp control module 2222 recognizes that the tubes 1606 and 1608 are pre-tacked. In such a case, clamp control module 2222 would engage auto-clamps 1602 and 1604 (either in or out of unison) when tubes 1606 and 1608 are properly aligned.

When clamp control module 2222 recognizes the presence of tubes 1606 and/or 1608, clamp control module 2222 communicates the information to IOC 1622. Accordingly, IOC 1622 can indicate to an operator the presence of one or both of tubes 1606 and 1608.

Alignment control module 2224 controls the operation of alignment system 1618. For example, upon startup, alignment control module 2224 initializes alignment system 1618. In addition, if orbital welder 1600 included tube size detecting means, alignment control module 2224 would perform any adjustments necessary to alignment system 1618 and/or to the alignment process of clamp control module 2222 in response to changing tube diameters.

For example, alignment control module 2224 could be operative to adjust the predetermined intensity values for causing clamps 1602 and 1604 to close. In such a case, alignment control module 2224 is operative to load new predetermined values into clamp control module 2222 corresponding to the diameter of tubes 1606. Such predetermined intensity values could be determined, for example, by looking them up in a look-up table or database (both not shown) stored in non-volatile memory 2206 or working memory 2216.

Alternately, alignment control module 2224 could be operative to adjust the position of alignment system 1618 directly. To adjust the position of alignment system 1618, alignment control module 2224 first determines the initial position of alignment system 1618 via alignment system interface 2210 (and a corresponding control line interfaced with alignment system 1618). After determining the initial position of alignment system 1618, alignment control module 2224 determines the needed position of alignment system 1618 based on the diameter of tube 1606. Then, if the position of alignment system 1618 needs to be adjusted, alignment control module 2224 sends adjustment signals to the adjustment means (e.g., servo motors, sliders etc.) acting on alignment system 1618 via alignment system interface 2210. As discussed above in FIG. 3, the position of the light source and/or light detector can be adjusted by many different varieties of adjustment means.

Alignment control module 2224 performs the additional function of communicating intensity data and tube data to IOC 1622 via IOC interface 2212 and IOC signal line 1632. As intensity data is received from alignment system 1618, alignment control module 2224 forwards such data to IOC interface 2212 such that the alignment data can be displayed on IOC 1622. In addition, alignment control module 2224 also sends target intensity information to IOC 1622 via interface 2212. Optionally, if an operator of orbital welder 1600 wanted to enter a customizable target intensity (e.g., target intensity 1130) into IOC 1622, alignment control module 2224 is operative to receive the target intensity via IOC interface 2212 and instruct clamp control module 2222 to load the target intensity value. In addition, if IOC 1622 included means for an operator to indicate to system controller the diameter of tubes 1606 and 1608, alignment control module 2224 would receive the diameter from IOC 1622 and adjust the position of alignment system 1618 or alter target intensity values accordingly.

Weld process module 2226 coordinates the welding process of tubes 1606 and 1608 once they are aligned in orbital welder 1600. Responsive to clamp control module 2222 indicating that the weld process can start, weld process module 2226 instructs rotation and voltage controller 1614 to weld tubes 1606 and 1608 together via RVC interface 2208. After instructing rotation and voltage controller 1614 to start the welding process, weld process module 2226 waits to receive indication from rotation and voltage controller 1614 via interface 2208 that the weld process is completed. Once the welding process is complete, weld process module 2226 indicates to clamp control module 2222 that it is safe to open clamps 1602 and 1604.

If during the welding process of tubes 1606 and 1608, an open clamp signal is received via IOC interface 2212, then weld process module 2226 is operative to instruct rotation and voltage controller 1614 to stop the welding process such that tubes 1606 and 1608 can be released. The foregoing ability of weld process module 2226 serves as an emergency stop feature for the operator of welder 1600. In an alternate embodiment, the weld process can be finished even if an open clamp signal is received via IOC interface 2212.

Finally, applications 2228 designate various applications running in working memory 2216 that aid the operation of orbital welder 1600. For example, an application might be running to automatically power a compressor to provide air pressure to the pneumatic solenoids 1732 of auto-clamps 1602 and 1604. As another example, clamps 1602 and 1604 might include pressure sensors that monitor the pressure clamps 1602 and 1604 are placing on tubes 1606 and 1608. Accordingly, applications 2228 might include an application which would adjust the force applied by clamps 1602 and 1604 by adjusting the pressure of air supplied to clamps 1602 and 1604.

FIG. 23 shows one example of combination indicator and operator controller 1622. IOC 1622 includes a measured intensity field 2328, a target intensity field 2330, a first indicator light 2332, a second indicator light 2334, and a plurality of selector keys 2336, each of which functions similarly to measured intensity field 1128, target intensity field 1130, first indicator light 1132, second indicator light 1134, and selector keys 1136 of indicator 1126 of FIG. 11.

IOC controller 1622 also includes a start weld button 2338, a continue button 2340, an open clamps button 2342, tube indicator lights 2344(1-2), and clamp closed indicator lights 2346(1-2). Start weld button 2338 permits the operator of orbital welder 1600 to initiate the welding process of tubes 1606 and 1608 by generating a weld signal to system controller 1620. Continue button 2340 allows the operator of welder 1600 to indicate to system controller 1620 that particular portions of the alignment operation are completed. For example, by pressing continue button 2340, the operator of welder 1600 could indicate to system controller 1620 that the rotation of second tube 1608 is complete. Open clamps button 2342 allows the operator to release clamps 1602 and 1604 from their closed state by sending an open clamp signal to system controller 1620 when pressed. Open clamp button 2342 also serves as an emergency stop button causing orbital welder 1600 to immediately stop the welding process if pressed while orbital welder 1600 is welding tubes 1606 and 1608 together. Tube indicator lights 2344(1-2) indicate the presence of tubes 1606 and 1608 in clamps 1602 and 1604, respectively. Responsive to receiving indication of the presence of either tubes 1606 and/or 1608 in clamps 1602 and 1604 from system controller 1620, an associated one of tube indicator lights 2344(1-2) is illuminated. Finally, clamp closed indicator lights 2346(1-2) indicate if clamps 1602 and 1604, respectively, are in a closed position. Responsive to a signal received from system controller 1620 that either of clamps 1602 or 1604 is in a closed position, the associated clamp closed indicator light 2346(1-2) is illuminated.

It should be noted that the embodiment of IOC controller 1622 is exemplary in nature. Indeed, other indicators and/or control functions can be added or omitted as necessary. For example, a tube size selector (e.g., a selector switch, keyed input, etc.) could be integrated into IOC controller 1622 such that system controller 1620 would know the size of tubes 1606 and 1608, and any adjustments deemed necessary could be made to alignment system 1618 or target intensity values altered by alignment control module 2224. As another example, tube indicator lights 2344(1-2) could optionally be omitted. As still another example, an open clamp button could be provided for each clamp 1602 and 1604 independently. As yet another example, IOC controller 1622 could also perform the functions of indicator 1126 shown in FIG. 11. Indeed, these and other modifications to IOC 1622 are possible.

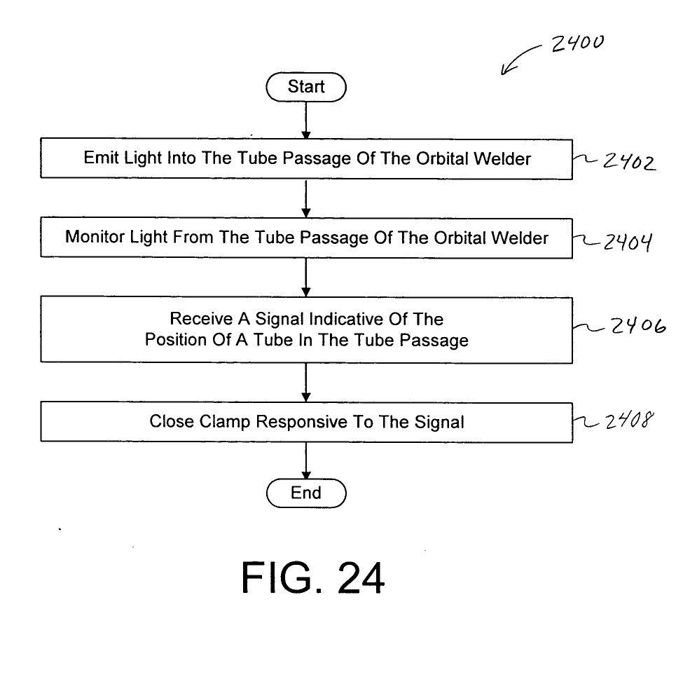

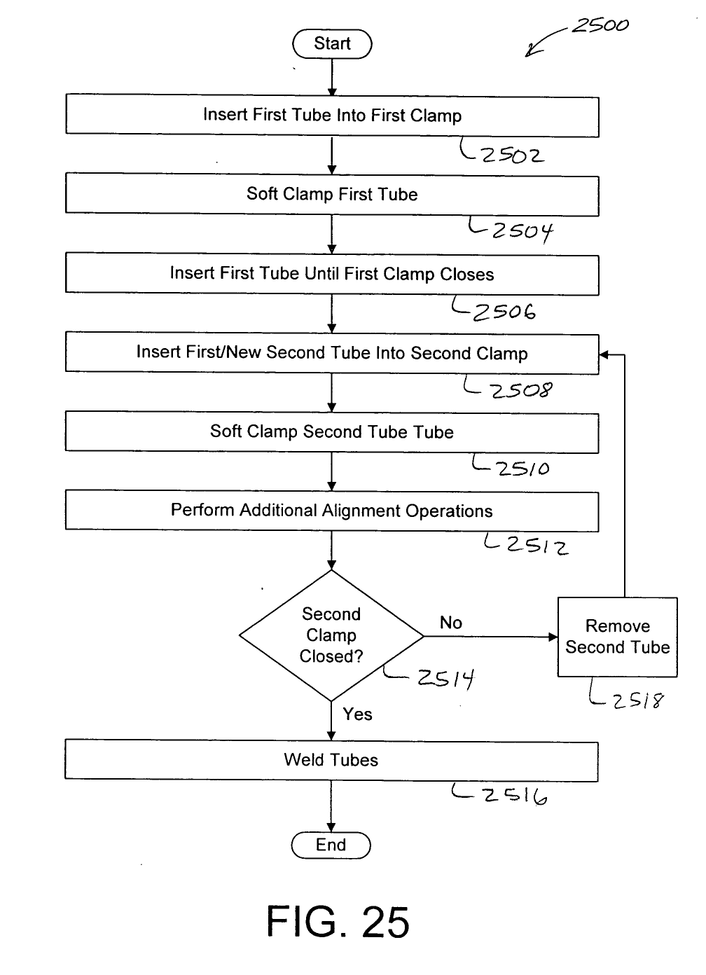

The methods of the present invention will now be described with respect to FIGS. 24-25. Although these methods are described with reference to particular elements performing particular functions, it should be noted that other elements, whether explicitly described herein or created in view of the present disclosure, could be substituted for those cited without departing from the scope of the present invention. Accordingly, the methods described herein are in no way limited based on the element(s) that perform(s) the particular function(s). In addition, the format of the methods disclosed herein should also not be construed as limiting in any way. For example, extra method steps may be interposed between any two method steps disclosed. In other instances, particular steps may be eliminated, while in other cases two or more steps may occur simultaneously. These and other variations of the particular methods disclosed herein will be readily apparent, especially in view of the description of the present invention provided previously herein.

FIG. 24 is a flowchart summarizing one method 2400 for receiving a signal used to automatically clamp a tube in an orbital welder according to the present invention. In a first step 2402, light is emitted from the light source of alignment system 1618 (e.g., light source 320) into the tube passage 314 of orbital welder 1600. Then, in a second step 2404, light is monitored from tube passage 314 by a light detector (e.g., light detector 322) of alignment system 1618. Following, in a third step 2406, system controller 1620 receives a signal indicative of the intensity of light monitored from tube passage 314 by light detector 322 from alignment system 1618. Finally, in a fourth step 2408, system controller 1620 is operative to automatically close clamp 1602 responsive to the signal received from alignment system 1618.

Although method 2400 is described with reference to welder 1600 incorporating the alignment system of FIG. 3, method 2400 is equally applicable to an orbital welder incorporating the alternate embodiments of the alignment system, such as those described in FIGS. 7 and 8.

FIG. 25 is a flowchart summarizing one method 2500 for welding two tubes together using an orbital welder (e.g., orbital welder 1600) having an automatic clamping system of the present invention. In a first step 2502, an operator of orbital welder 1600 inserts a first tube 1606 (or optionally a tube fitting) into the clamping passage 1802 of first clamp 1602 and into the tube passage 314 of orbital welder 1600. Then in a second step 2504, an operator of welder 1600 soft-clamps tube 1606 in first clamp 1602 by closing lower jaw 1708 and latching it to second arm 1706 of clamp 1602. Then in a third step 2506, the operator of welder 1600 slowly inserts tube 1606 into tube passage 314 until clamp 1602 closes (when a first predetermined intensity is detected), thereby locking tube 1606 in position. Following in a fourth step 2508, the operator inserts second tube 1608 into the clamping passage 1802 of second clamp 1604 and into tube passage 314 of orbital welder 1600 until it abuts the mating end of first tube 1602. Following in a fifth step 2510, the operator of welder 1600 soft-clamps second tube 1608 in second clamp 1604. In a sixth step 2516, additional alignment operations are performed on second tube 1608. In particular, second tube 2510 is rotated so that system controller 1620 can determine if the mating end of second tube 1608 is misaligned in any way with first tube 1606. After rotating second tube 1608, the operator of welder 1600 determines in a seventh step 2514 if second clamp 1604 is closed (e.g., by visually checking IOC 1622 or clamp 1604 directly). If second clamp 1604 is closed (e.g., the intensity signal did not deviate outside a predetermined range of a second predetermined intensity), then in an eighth step 2516 the operator of welder 1600 instructs system controller 1620 to weld tubes 1606 and 1608 together by pushing start weld button 2338 on indicator 1622.

If in seventh step 2514 the operator of orbital welder 1600 determines that second clamp 1604 is not closed, then in a ninth step 2518, the operator removes second tube 1608 from clamp 1604 and tube passage 314, and method 2500 returns to fourth step 2508 wherein a new second tube 1608 is inserted in second clamp 1604.

The description of particular embodiments of the present invention is now complete. Many of the described features may be substituted, altered or omitted without departing from the scope of the invention. For example, the system controller could alternately receive intensity information from an indicator, rather than directly from the alignment system. As another example, the system controller could be readily incorporated into the orbital welder itself. It should be noted that the clamping system of the present invention is not limited to orbital welders designed to make flat, circular welds, but could be also be incorporated into orbital welders designed to make “notched-T welds,” “oblique end-to-end” welds, or other specific weld types that require exact alignment of tubes and/or fittings. Further, the reflectance/transmittance percentage ranges set forth herein were found to be suitable for one particular application. It is anticipated however, that these ranges will be slightly modified depending on the particular physical characteristics (e.g., tube composition, etc.) of an application. Such range modifications can be easily determined empirically. These and other modifications will be apparent to those skilled in the art in light of the present disclosure.

I claim:

1. An orbital welder comprising:
a body defining a tube passage;
a weld tip;
a light source disposed to emit light toward said tube passage such that said emitted light will at least partially impinge upon a tube placed in said tube passage;
a detector disposed to detect said light emitted by said light source from said tube passage;
at least one clamp disposed adjacent said tube passage; and
a control unit operative to close said clamp responsive to a signal from said detector.

2. An orbital welder according to claim 1, wherein:
said signal is an intensity signal; and
said control unit is operative to close said clamp responsive to said detector detecting a first predetermined intensity indicative of a mating end of said tube aligning with said weld tip.

3. An orbital welder according to claim 2, further comprising:
a second clamp disposed adjacent said tube passage, opposite said clamp; and
wherein said control unit is further operative to close said second clamp responsive to a second signal from said detector.

4. An orbital welder according to claim 3, wherein:
said second signal is an intensity signal; and
said control unit is operative to close said second clamp responsive to said detector detecting a second predetermined intensity indicative of alignment of a mating end of a second tube with said mating end of said first tube and said weld tip.

5. An orbital welder according to claim 4, wherein said control unit is further operative to:
determine if the intensity of said detected light deviates beyond a predetermined range of said second predetermined intensity before closing said second clamp when said second tube is rotated; and
prevent said second clamp from closing if said intensity deviates beyond said predetermined range.

6. An orbital welder according to claim 5 further comprising an operator controller responsive to instructions from an operator of said orbital welder, and operative to indicate to said control unit that rotation of said second tube is complete.

7. An orbital welder according to claim 3, wherein said control unit is further operative to cause said weld tip to weld said first tube and said second tube together after closing said second clamp.

8. An orbital welder according to claim 7, wherein said control unit is further operative to open said clamp and said second clamp after said first tube and said second tube are welded together.

9. An orbital welder according to claim 3, further comprising an operator controller responsive to instructions from an operator of said orbital welder and operative to instruct said control unit to cause said weld tip to weld said first tube and said second tube together after said second clamp is closed.

10. An orbital welder according to claim 1, further comprising an operator controller responsive to instructions from an operator of said orbital welder and operative to cause said control unit to open said at least one clamp.

11. An orbital welder according to claim 1, further comprising an indicator responsive to said signal from said detector and operative to display alignment data indicative of the alignment of a mating end of said tube with respect to said weld tip.

12. An orbital welder according to claim 11, wherein said indicator is further operative to display alignment data indicative of the alignment of a mating end of a second tube placed in said tube passage with respect to said mating end of said first tube.

13. An orbital welder according to claim 1, further comprising a tube size detector operative to determine the diameter of a tube placed in said clamp.

14. An orbital welder according to claim 1, wherein said clamp includes:
a clamping passage for receiving said tube; and
a plurality of positioning tabs disposed about a perimeter of said clamping passage, said positioning tabs centering said tube in said clamping passage.

15. An orbital welder according to claim 1, wherein:
said clamp includes an actuator disposed to close said clamp; and
said control unit is further operative to activate said actuator to close said clamp.

16. An orbital welder according to claim 15, wherein said actuator comprises a solenoid having an extendable ram.

17. An orbital welder according to claim 15, wherein said actuator comprises a jack screw driven by an electric motor.

18. In an orbital welder having a tube passage, a light source, a light detector, and at least one clamp, a method comprising:
emitting light from said light source into said tube passage;
monitoring light from said tube passage with said detector;
receiving a signal from said detector indicative of the position of a tube in said tube passage; and
closing said clamp responsive to said signal from said detector.

19. A method according to claim 18, wherein:
said signal is an intensity signal; and
said step of closing said clamp includes closing said clamp when a first predetermined intensity is received from said detector indicative of a mating end of said tube aligning with said weld tip.

20. A method according to claim 19, wherein:
said orbital welder includes a second clamp; and
said method further comprises closing said second clamp when a second predetermined intensity is received from said detector indicative of a mating end of said second tube aligning with said mating end of said first tube.

21. A method according to claim 20, further comprising:
monitoring light from said tube passage with said detector while said second tube is rotated prior to closing said second clamp;
receiving a signal from said detector indicative of the intensity of said monitored light deviating from said second predetermined intensity; and
preventing said second clamp from closing if the intensity of said monitored light deviates from within a predetermined range while said second tube is rotated.

22. A method according to claim 21, further comprises receiving instructions from an operator controller indicative of the completion of said step of monitoring said light from said tube passage while said second tube is rotated.

23. A method according to claim 20, further comprising welding said first tube and said second tube together.

24. A method according to claim 23, further comprising opening said first clamp and said second clamp.

25. A method according to claim 18, further comprising providing tube alignment data to an indicator, said tube alignment data indicative of the alignment of a mating end of said tube with respect to a weld tip of said orbital welder.

26. A method according to claim 18, further comprising determining the diameter of said tube placed in said tube passage.

27. A method according to claim 18, wherein said step of closing said clamp includes activating an actuator disposed to forcibly close said clamp.

28. An electronically readable medium having code embodied thereon for causing an electronic device to perform the method of claim 18.

29. An orbital welder comprising:
a body defining a tube passage;
a weld tip;
at least one clamp disposed adjacent said tube passage, said clamp having a clamping passage for grasping said tube;
means for emitting light into said tube passage and detecting said light from said tube passage such that the intensity of detected light depends on the position of said tube; and
means for automatically engaging said clamp responsive to the intensity of said detected light.

30. An orbital welder comprising:
a weld tip;
at least one clamp;
an optical sensor disposed to detect the position of a tube with respect to said weld tip; and
a control unit operative to automatically close said clamp responsive to a signal from said optical sensor indicative of the position of a mating end of said tube with respect to said weld tip.

31. In an orbital welder having a weld tip, an optical sensor, and at least one clamp, a method comprising:
monitoring the intensity of light near said weld tip with said optical sensor; and
receiving a signal from said optical sensor indicative of the position of a mating end of a tube with respect to said weld tip; and
closing said clamp responsive to said signal from said optical sensor.

32. A clamp comprising:
a frame having a first arm and a second arm;
a first jaw rotatably coupled to said first arm and adapted to selectively engage said second arm, said first jaw defining a first portion of a clamping passage for receiving a tube therein;
a second jaw slidably mounted to said first arm and said second arm, said second jaw defining a second portion of said clamping passage complementary to said first portion of said clamping passage; and
a force actuator disposed to engage said second jaw and to move said second jaw toward said first jaw when said force actuator is activated.

33. A control system for automatically closing a clamp, said control system comprising:
a processing unit for processing data and code;
an alignment system interface operative to receive a signal from an alignment system indicative of the position of a tube with respect to a weld tip of an orbital welder;
a clamp interface operative to transmit a close signal to said clamp to cause said clamp to close; and
a memory device for storing said data and code, said code including a clamp control module operative to cause said clamp interface to transmit said close signal to said clamp responsive to said alignment interface receiving said signal from said alignment system.
